(19) United States
(12) Patent Application Publication
(10) Pub. No.: US 2024/0357633 A1
(43) Pub. Date: Oct. 24, 2024

(54) TERMINAL AND RADIO COMMUNICATION METHOD

(71) Applicant: NTT DOCOMO, INC., Tokyo (JP)

(72) Inventors: Yuki Takahashi, Chiyoda-ku, Tokyo (JP); Satoshi Nagata, Chiyoda-ku, Tokyo (JP); Pi Qiping, Beijing, Haidian District (CN); Jing Wang, Beijing, Haidian District (CN); Lan Chen, Beijing, Haidian District (CN)

(73) Assignee: NTT DOCOMO, INC., Tokyo (JP)

(21) Appl. No.: 18/683,439

(22) PCT Filed: Aug. 16, 2022
(86) PCT No.: PCT/JP2022/030937

§ 371 Date: Feb. 13, 2024

(30) Foreign Application Priority Data
Aug. 17, 2021 (JP) 2021-132978

(51) Int. Cl. H04W 72/56; H04W 72/04

(52) U.S. Cl. CPC H04W 72/56; H04W 72/04

(57) ABSTRACT

UL transmission is appropriately controlled even when a plurality of UL transmissions having different priorities overlap. A terminal according to an aspect of the present disclosure includes: a control section that controls simultaneous transmission of an uplink control channel and an uplink shared channel in at least one of a plurality of steps when, in at least one of a case in which a plurality of UL transmissions having a same priority overlap and a case in which a plurality of UL transmissions having different priorities overlap, the overlap is resolved using the plurality of steps; and a transmitting section that performs the UL transmissions in which the overlap is resolved.

### TECHNICAL FIELD

The present disclosure relates to a terminal and a radio communication method in next-generation mobile communication systems.

### BACKGROUND ART

In a universal mobile telecommunications system (UMTS) network, specifications of long term evolution (LTE) have been drafted for the purpose of further increasing data rates, providing low latency, and the like (Non Patent Literature 1). The specifications of LTE-Advanced (third generation partnership project (3GPP) Release (Rel.) 10 to 14) have been drafted for the purpose of further increasing capacity and advancement of LTE (3GPP Rel. 8 and 9).

Successor systems to LTE (for example, also referred to as 5th generation mobile communication system (5G), 5G+ (plus), New Radio (NR), or 3GPP Rel. 15 or later) are also being studied.

### CITATION LIST

### Non Patent Literature

Non Patent Literature 1: 3GPP TS 36.300 V8.12.0 “Evolved Universal Terrestrial Radio Access (E-UTRA) and Evolved Universal Terrestrial Radio Access Network (E-UTRAN); Overall description; Stage 2 (Release 8)”, April 2010

### SUMMARY OF INVENTION

### Technical Problem

Future radio communication systems (such as 5G or NR) are expected to involve a plurality of services (also referred to as use cases, communication types, or the like) having different requirements such as higher speed and larger capacity (for example, enhanced mobile broad band (eMBB)), a massive amount of terminals (for example, massive machine type communication (mMTC) or Internet of Things (IoT)), and ultrahigh reliability and low latency (for example, ultra-reliable and low-latency communications (URLLC)).

For example, in Rel. 16 and later, it has been studied that priorities are set for signals/channels and communication is controlled based on the priorities set for the signals/channels. For example, it is assumed that, when a plurality of signals/channels overlap, transmission and reception are controlled based on the priorities of the signals/channels.

On the other hand, in a future radio communication system (for example, Rel. 17 or later), a case is also conceivable in which a plurality of UL transmissions respectively transmitted on different carriers (or cells or CCs) overlap in a time domain and priorities among the plurality of UL transmissions are different.

In such a case, it is also assumed that simultaneous transmission of UL transmissions with different priorities is allowed. Alternatively, it is assumed that, depending on a UE capability or the like, even when a plurality of UL transmissions having different priorities overlap, UL signals having different priorities are allowed to be multiplexed/mapped on a given UL channel. In this way, it is not sufficiently studied how to control UL transmissions when a plurality of UL transmissions having different priorities are set/scheduled in the same time domain.

Therefore, an object of the present disclosure is to provide a terminal and a radio communication method that, even when a plurality of UL transmissions having different priorities overlap, can appropriately control the UL transmissions.

### Solution to Problem

A terminal according to an aspect of the present disclosure includes: a control section that controls simultaneous transmission of an uplink control channel and an uplink shared channel in at least one of a plurality of steps when, in at least one of a case in which a plurality of UL transmissions having a same priority overlap and a case in which a plurality of UL transmissions having different priorities overlap, the overlap is resolved using the plurality of steps; and a transmitting section that performs the UL transmissions in which the overlap is resolved.

### Advantageous Effects of Invention

According to an aspect of the present disclosure, even when a plurality of UL transmissions having different priorities overlap, it is possible to appropriately control the UL transmissions.

### BRIEF DESCRIPTION OF DRAWINGS

FIG. 1A and FIG. 1B are diagrams illustrating an example of UL transmission control based on a priority.

FIG. 2 is a diagram illustrating another example of the UL transmission control based on the priorities.

FIG. 3 is a diagram illustrating an example of a collision handling framework in Rel. 16.

FIG. 4 is a diagram illustrating an example of a collision handling framework assumed in Rel. 17 and later.

FIG. 5 is a diagram illustrating another example of the collision handling framework assumed in Rel. 17 and later.

FIG. 6 is a diagram illustrating an example of a collision handling framework in a first aspect.

FIG. 7A and FIG. 7B are diagrams illustrating an example of UL transmission control in a collision case in the first aspect.

FIG. 8 is a diagram illustrating another example of a collision handling framework in a first aspect.

FIG. 9 is a diagram illustrating another example of the collision handling framework in the first aspect.

FIG. 10A and FIG. 10B are diagrams illustrating another example of the UL transmission control in the collision case in the first aspect.

FIG. 11 is a diagram illustrating another example of the UL transmission control in the collision case in the first aspect.

FIG. 12 is a diagram illustrating another example of the UL transmission control in the collision case in the first aspect.

FIG. 13 is a diagram illustrating another example of the UL transmission control in the collision case in the first aspect.

FIG. 14A and FIG. 14B are diagrams illustrating another example of the UL transmission control in the collision case in the first aspect.

FIG. 15 is a diagram illustrating another example of the UL transmission control in the collision case in the first aspect.

FIG. 16 is a diagram for explaining conditions for PUCCHs/PUSCHs simultaneous transmission.

FIG. 17 is a diagram illustrating an example of a schematic configuration of a radio communication system according to an embodiment.

FIG. 18 is a diagram illustrating an example of a configuration of a base station according to one embodiment.

FIG. 19 is a diagram illustrating an example of a configuration of a user terminal according to one embodiment.

FIG. 20 is a diagram illustrating an example of a hardware configuration of the base station and the user terminal according to one embodiment.

### DESCRIPTION OF EMBODIMENTS

### <Traffic Type>

Future radio communication systems (for example, NR) are expected to involve traffic types (also referred to as services, service types, communication types, use cases, or the like) such as an enhanced mobile broadband (eMBB), machine type communications that embody multiple simultaneous connection (for example, massive machine type communications (mMTC), and Internet of Things (IoT)), and ultra-reliable and low-latency communications (URLLC). For example, it is required that the URLLC have smaller latency and higher reliability than the eMBB.

The traffic type may be identified in a physical layer based on at least one of the following.
Logical channels with different priority levels (priorities)
Modulation and coding scheme (MCS) table (MCS index table)
Channel quality indication (CQI) table
DCI format
System information-radio network temporary identifier (RNTI) used for scrambling (masking) of cyclic redundancy check (CRC) bit included in (added to) DCI (DCI format)
Radio resource control (RRC) parameter
Specific RNTI (for example, RNTI for URLLC, MCS-C-RNTI, or the like)
Search space
Given field in DCI (for example, newly added field or reuse of existing field)

Specifically, a traffic type of HARQ-ACK for PDSCH may be determined based on at least one of the following.
MCS index table used to determine at least one of the modulation order, target code rate, and transport block size (TBS) of the PDSCH (for example, whether to use MCS index table 3)
RNTI used for CRC scrambling of DCI used for scheduling the PDSCH (for example, whether CRC scrambled with C-RNTI or MCS-C-RNTI)

A traffic type of the SR may be determined based on a higher layer parameter used as an SR identifier (SR-ID). The higher layer parameter may indicate whether the traffic type of the SR is eMBB or URLLC.

A traffic type of the CSI may be determined based on configuration information regarding CSI report (CSI report setting), a DCI type used for triggering, a DCI transmission parameter, or the like. The configuration information, the DCI type, or the like may indicate whether the traffic type of the CSI is eMBB or URLLC. The configuration information may be a higher layer parameter.

A traffic type of a physical uplink shared channel (PUSCH) may be determined based on at least one of the following.
MCS index table used to determine at least one of modulation order, target code rate, and transport block size (TBS) of PUSCH (for example, whether to use MCS index table 3).
RNTI used for CRC scrambling of DCI used for scheduling of PUSCH (for example, whether CRC scrambling is performed using C-RNTI or using MCS-C-RNTI)

The traffic type may be associated with communication requirements (requirements such as latency and error rate), a data type (voice, data, or the like), or the like.

URLLC requirements and eMBB requirements may be different in that the URLLC is lower in latency than the eMBB or the URLLC requirements include a reliability requirement.

For example, eMBB user (U)-plane latency requirements may include that downlink U-plane latency is 4 ms and that uplink U-plane latency is 4 ms. Meanwhile, URLLC U-plane latency requirements may include that downlink U-plane latency is 0.5 ms and that uplink U-plane latency is 0.5 ms. The URLLC reliability requirements may include that a 32-byte error rate is 10-5 for a U-plane latency of 1 ms.

In contrast, enhancement of the reliability of traffic for unicast data is mainly studied as enhanced ultra reliable and low latency communications (eURLLC). In the following explanation, in a case in which URLLC and eURLLC are not distinguished, they are simply referred to as URLLC.

### <Setting of Priorities>

In the NR after Rel. 16, setting priorities at a plurality of levels (for example, two levels) for a given signal or channel has been studied. For example, it is assumed that different priorities are set for each of signals or channels respectively corresponding to different traffic types (also referred to as services, service types, communication types, use cases, and the like) to control communication (for example, transmission control at the time of collision). This makes it possible to control communication by setting different priorities for the same signal or channel according to a service type or the like.

The priority may be set for at least one of a signal (for example, UCI such as HARQ-ACK or a reference signal), a channel (PDSCH, PUSCH, PUCCH, or the like), a reference signal (for example, channel state information (CSI) or sounding reference signal (SRS)), a scheduling request (SR), and a HARQ-ACK codebook. Priorities may be respectively set for a PUCCH used for SR transmission, a PUCCH used for HARQ-ACK transmission, and a PUCCH used for CSI transmission.

The priorities may be defined by a first priority (for example, high) and a second priority (for example, low) lower than the first priority. In the following explanation, the first priority is referred to as HP and the second priority is also referred to as LP. Alternatively, three or more types of priorities may be set.

For example, priorities may be set for HARQ-ACK for PDSCH that is dynamically scheduled, HARQ-ACK for semi-persistent PDSCH (semi-persistent scheduling (SPS) PDSCH), and HARQ-ACK for SPS PDSCH release. Alternatively, priorities may be set for HARQ-ACK codebooks corresponding to these HARQ-ACKs. Note that, when a priority is set for the PDSCH, priority of the PDSCH may be replaced with priority of HARQ-ACK for the PDSCH.

Priorities may be set for a dynamic grant-based PUSCH, a set grant-based PUSCH, or the like.

The information regarding the priorities may be notified from a base station to the UE using at least one of higher layer signaling and DCI. For example, the priority of the scheduling request may be set by a higher layer parameter (for example, schedulingRequestPriority). The priority of the HARQ-ACK for the PDSCH (for example, dynamic PDSCH) scheduled by the DCI may be notified by the DCI. The priority of the HARQ-ACK for the SPS PDSCH may be set by an upper parameter (for example, HARQ-ACK-Codebook-indicator-forSPS) or may be notified by DCI indicating activation of the SPS PDSCH. A given priority (for example, low) may be set for P-CSI/SP-CSI transmitted on the PUCCH. On the other hand, the priority of A-CSI/SP-CSI transmitted on the PUSCH may be notified by DCI (for example, trigger DCI or activation DCI).

The priority of the dynamic grant-based PUSCH may be notified by DCI for scheduling the PUSCH. The priority of the set grant-based PUSCH may be set by a higher layer parameter (for example, a priority). A given priority (for example, low) may be set for the P-SRS/SP-SRS and the A-SRS triggered by the DCI (for example, DCI format 0_1/DCI format 2_3).

### (Overlap of UL Transmissions)

The UE may control UL transmissions based on priorities when a plurality of UL signals/UL channels overlap (or collide).

The plurality of UL signals/UL channels overlapping may be a case in which time resources (or time resources and frequency resources) of the plurality of UL signals/UL channels overlap or a case in which transmission timings of the plurality of UL signals/UL channels overlap. Time resource may be replaced with time region or time domain. The time resource may be in units of symbols, slots, sub-slots, or subframes.

The plurality of UL signals/UL channels overlapping in the same UE (for example, intra-UE) may mean that the plurality of UL signals/UL channels overlap at least in the same time resource (for example, symbol). The UL signal/UL channel colliding in different UEs (for example, inter-UEs) may mean that the plurality of UL signals/UL channels overlap in the same time resource (for example, symbol) and the same frequency resource (for example, RB).

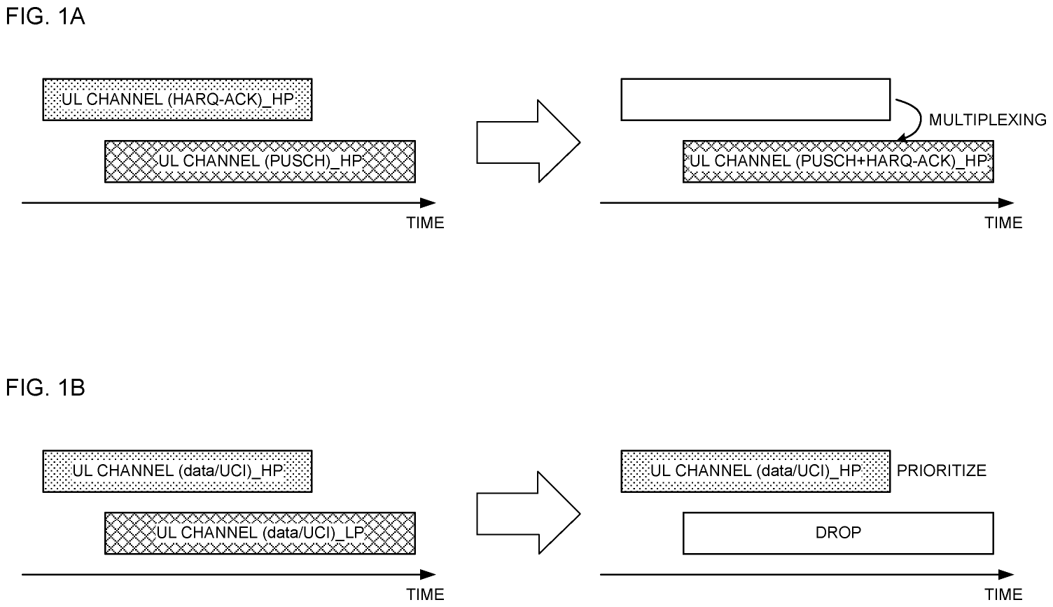

For example, when a plurality of UL signals/UL channels having the same priority overlap, the UE performs control to multiplex the plurality of UL signals/UL channels on one UL channel and transmit the UL signals/UL channels (see FIG. 1A).

FIG. 1A illustrates a case in which HARQ-ACK (or PUCCH for HARQ-ACK transmission) for which the first priority (HP) is set and UL data/UL-SCH (alternatively, the PUSCH for UL data/UL-SCH transmission) for which the first priority (HP) is set overlap each other. In this case, the UE multiplexes (or maps) the HARQ-ACK on the PUSCH and transmits both the UL data and the HARQ-ACK.

When a plurality of UL signals/UL channels having different priorities overlap, the UE may perform control to perform the UL transmission having a high priority (for example, prioritize UL transmission with high priority) and not to perform (for example, to drop) the UL transmission having low priority (see FIG. 1B).

FIG. 1B illustrates a case in which UL data/HARQ-ACK (or a UL channel for UL data/HARQ-ACK transmission) for which the first priority (HP) is set and UL data/HARQ-ACK (or a UL channel for UL data/HARQ-ACK transmission) for which the second priority (LP) is set overlap. In this case, the UE performs control to drop the UL data/HARQ-ACK having a low priority and to prioritize and transmit the UL data/HARQ-ACK having a high priority. Note that the UE may change (for example, defer or shift) transmission timing of the UL transmission having a low priority.

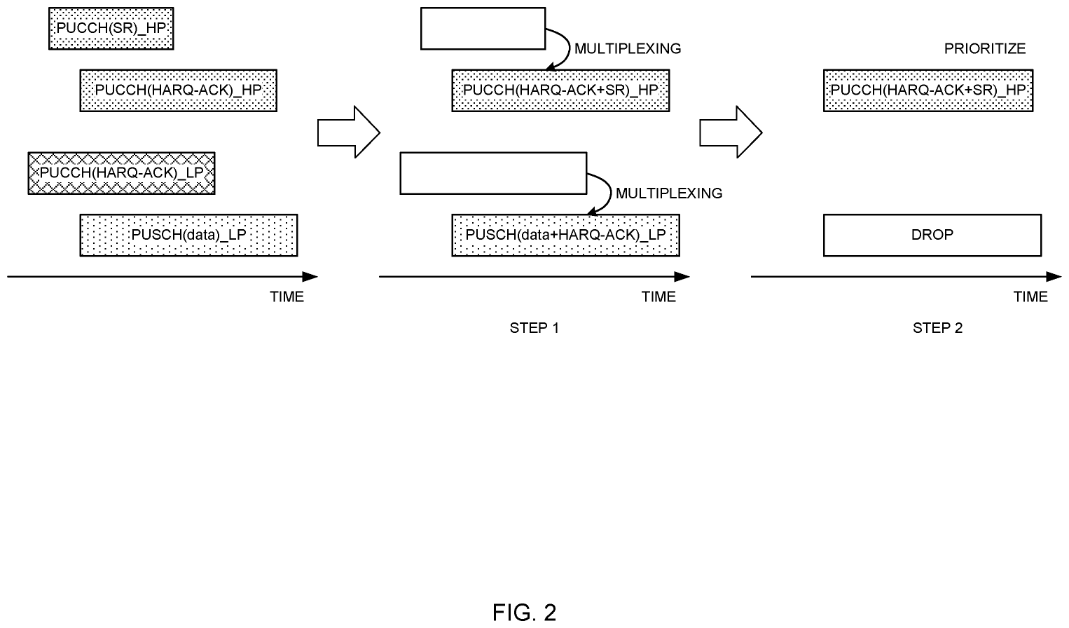

When more than two (or three or more) UL signals/UL channels overlap in the time domain, the transmission may be controlled by two steps (see FIG. 2).

In step 1, one UL channel for multiplexing UL signals respectively transmitted in UL transmissions having the same priority is selected. In FIG. 2, SR (or PUCCH for SR transmission) having the first priority (HP) and HARQ-ACK (or PUCCH for transmission of HARQ-ACK) may be multiplexed on a given UL channel (here, the PUCCH for HARQ-ACK transmission). Similarly, HARQ-ACK (or PUCCH for transmission of HARQ-ACK) having the second priority (LP) and data (or PUSCH for data/UL-SCH transmission) may be multiplexed on a given UL channel (here, the PUSCH).

In step 2, control may be performed to preferentially transmit UL transmission having a high priority and drop UL transmission having a low priority between UL transmissions having different priorities. In FIG. 2, the SR having the first priority (HP) and the PUCCH for HARQ-ACK transmission may be preferentially transmitted and the HARQ-ACK having the second priority (LP) and the PUSCH for data transmission may be dropped.

In this way, the UE can resolve collisions among the plurality of UL transmissions having the same priority according to step 1 and resolve collisions among the plurality of UL transmissions having different priorities according to step 2.

In FIG. 2, the multiplexing processing between the UL transmissions having the same priority is performed in step 1 However, the present disclosure is not limited thereto. For example, in step 1, the multiplexing processing may be performed first on the UL transmissions having the low priority (for example, the second priority) among the plurality of overlapping UL transmissions and the multiplexing processing for the UL transmissions having the high priority (for example, the first priority) may be performed after step 2 (for example, multiplex processing between UL transmissions having different priorities).

### <Simultaneous Transmission/Multiplexing of UL Transmissions Having Different Priorities>

Incidentally, a case is also conceivable in which a plurality of UL transmissions respectively transmitted on different carriers (or cells or CCs) overlap in the time domain and priorities of the plurality of UL transmissions are different.

For example, when UL channels/UL signals are scheduled on different carriers of an inter-cell supported by different radio frequencies (RFs), transmitting the UL channels/UL signals is useful from the viewpoint of low delay and spectral efficiency. When the UE supports RF processing respectively for different carriers (CCs), it is possible to achieve improvement of use efficiency of resources and low delay by transmitting the UL channels/UL signals on the carriers.

For example, for each UE supporting an inter-band carrier aggregation (for example, inter-band CA) function, PUCCHs/PUSCHs simultaneous transmission in different priorities (for example, PHY priorities) in different cells being RRC-set in the same PUCCH group may be supported.

Alternatively, multiplexing UL transmissions having different priorities (transmitting the UL transmissions using the same UL channel) may be supported, for example, when a plurality of UL transmissions having different priorities are scheduled in a cell (intra-cell)/between cells (inter-cell). For example, the plurality of UL transmissions may be supported by multiplexing and transmitting UL transmission having a certain priority on a UL channel for UL transmissions having other priorities.

In a future radio communication system (for example, Rel. 17 or later), it is studied to multiplex high-priority (HP) HARQ-ACK and low-priority (LP) HARQ-ACK on PUCCH, multiplex low-priority (LP) HARQ-ACK and high-priority (HP) SR on PUCCH for a combination of PUCCH formats of HARQ-ACK/SR, and multiplex low-priority (LP) HARQ-ACK and high-priority (HP) HARQ-ACK and SR on PUCCH.

In the future radio communication system (for example, Rel. 17 or later), it is studied to multiplex the LP HARQ-ACK into the HP PUSCH, multiplex the HP HARQ-ACK into the LP PUSCH, multiplex the LP HARQ-ACK, the HP PUSCH that transmits the UL-SCH, and the HP HARQ-ACK/CSI, and multiplex the HP HARQ-ACK, the LP PUSCH that transmits the UL-SCH, and the LP HARQ-ACK/CSI.

In the future radio communication system (for example, Rel. 17 or later), it is studied to support simultaneous transmission of PUCCH/PUSCH in different cells at least for inter-band CA. It is studied to, for each UE having an inter-band CA function, make it possible to RRC-set, in the same PUCCH group, simultaneous transmission of PUCCH/PUSCH having different physical priorities (for example, PHY priorities) in different cells.

In Rel. 16 NR, the following operations ares defined in order to resolve overlap of UL channels having different priorities.
Function 1 (feature 1): Multiplexing of the same priorities
Function 1-1: Multiplexing of PUCCHs having the same priority
Function 1-2: Multiplexing of PUCCHs/PUSCHs having the same priority
Function 2: Prioritization among different priorities
Cancellation of an LP channel when overlapping an HP channel (for example, overlap of PUCCHs/PUSCHs)

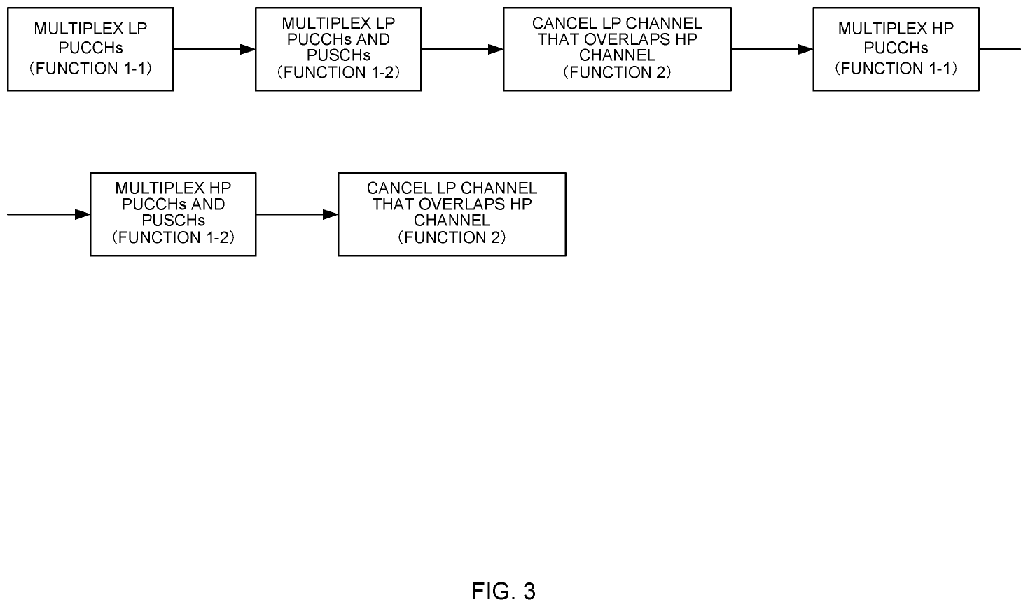

A framework for collision handling of Rel. 16 NR is defined as follows (see FIG. 3):
Multiplex LP channels (the function 1)
When an LP channel and an HP channel overlap, the LP channel is canceled (the function 2).
Multiplex HP channels (the function 1)
When an LP channel and an HP channel overlap, the LP channel is canceled (the function 2).

In Rel. 17 NR and later, it is assumed that multiplexing of different priorities (the function 3) and simultaneous transmission of PUCCH/PUSCH (the function 4) are introduced/supported. In order to resolve overlap of UL channels having different priorities, support for the following operations is conceivable.
Function 1 (feature 1): Multiplexing of the same priorities
Function 1-1: Multiplexing of PUCCHs having the same priority
Function 1-2: Multiplexing of PUCCHs/PUSCHs having the same priority
Function 2: Prioritization among different priorities
Cancellation of LP_PUCCHs/PUSCHs
Function 3: Multiplexing of different priorities
Function 3-1: Multiplexing of PUCCHs having different priorities
   HP_HARQ-ACK vs. LP_HARQ-ACK
   HP_SR vs. LP_HARQ-ACK
Function 3-2: Multiplexing of PUCCHs/PUSCHs having different priorities
   HP/LP_HARQ-ACK on LP/HP_PUSCH
   HP_HARQ-ACK, LP_HARQ-ACK on HP/LP_PUSCH with or without CSI
Function 4: Simultaneous transmission of PUCCH/PUSCH (Simultaneous PUCCHs/PUSCHs Tx)

For a framework of collision handling of PUCCHs/PUSCHs having different priorities, the following option 1 or option 2 is assumed.

### <Option 1>

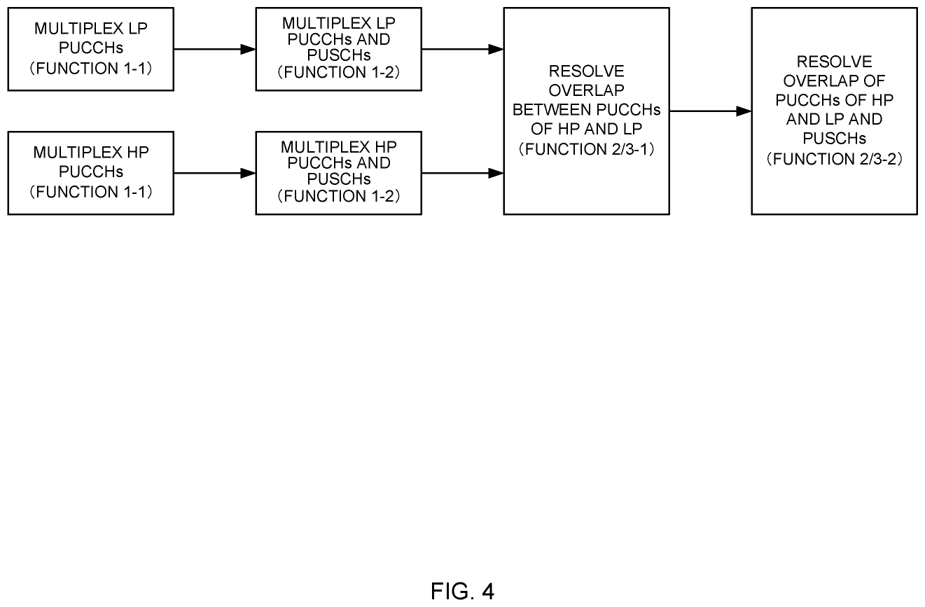

Multiplexing is performed first among overlapping channels having the same priority and, then, multiplexing is performed among channels having different priorities (see FIG. 4). For multiplexing between different priorities, first, PUCCHs may be multiplexed and, then, PUCCHs and PUSCHs may be multiplexed.

### <Option 2>

First, PUCCHs of HP and LP are multiplexed and, then, PUCCHs and In this case, Alt. 1 or Alt.2 may be assumed as a framework of collision handling of the PUCCHs of the HP and the LP.

### <<Alt. 1>>

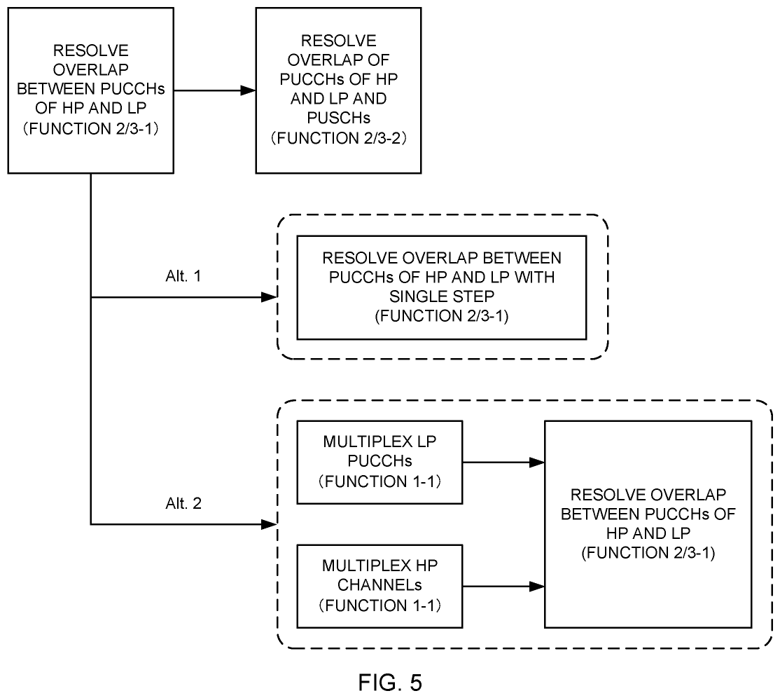

PUSCHs are multiplexed (see FIG. 5).

Multiplexing supported in Rel. 15 is used as a base line. Specifically, a single check/multiplexing step is performed among all the PUCCHs.

### <<Alt.2>>

After multiplexing (if any) among overlapping channels having the same priority is performed, a single check/multiplexing step is allowed among PUCCHs having different priorities.

In Rel. 17 and later, when simultaneous transmission of PUCCH/PUSCH (the function 4) is introduced/supported, how to control a framework of UL collision handling considering the simultaneous transmission of PUCCH/PUSCH (the function 4) is a problem.

For example, when the function 4 is introduced into the framework of the UL collision handling, how to cooperate with the other functions is a problem.

Alternatively, when simultaneous operation of the function 1-2 or the function 3-2 works together with the function 4 is supported, how to handle an interaction of UCI/PUSCH multiplexing and simultaneous PUCCHs/PUSCHs transmission is a problem. For example, how to control the order of the UCI/PUSCH multiplexing and the simultaneous PUCCHs/PUSCHs transmission or how to set/apply timeline requirements is a problem.

When the simultaneous PUCCHs/PUSCHs transmission is performed, influence on multiplexing of UCI/PUSCH is likely to occur.

The present inventors have conducted studies on UL collision handling in the case in which PUCCHs/PUSCHs simultaneous transmission is introduced/supported and conceived an aspect of the present embodiment.

In the following explanation, embodiments according to the present disclosure are explained in detail with reference to the drawings. Configurations explained in the embodiments may be respectively independently applied or may be applied in combination.

In the present disclosure, “A/B” and “at least one of A and B” may be replaced with each other. At least one of A and B may be replaced with A and B. Similarly, in the present disclosure, “A/B/C” and “at least one of A, B and C” may be replaced with each other. At least one of A, B, and C may be replaced with A and B, A and C, or B and C.

In the present disclosure, a higher layer signaling may be, for example, any of Radio Resource Control (RRC) signaling, Medium Access Control (MAC) signaling, broadcast information, and the like or a combination thereof.

For example, a MAC control element (MAC CE), a MAC protocol data unit (PDU), or the like may be used for the MAC signaling. The broadcast information may be, for example, a Master Information Block (MIB), a System Information Block (SIB), Remaining Minimum System Information (RMSI), Other System Information (OSI), or the like.

In the following explanation, two levels of the first priority (HP) and the second priority (LP) are explained as an example of priorities of UL transmission. However, priorities are not limited to the two levels. Priorities of three or more levels may be set.

In the present disclosure, UL transmission, UL channel, and UL signal may be replaced with one another. In the present disclosure, carrier, cell, CC, BWP, and band may be replaced with one another. In the present disclosure, “transmitted” may be replaced with scheduled, set, or allocated.

In the following explanation, PUSCH may be replaced with PUSCH transmission, PUSCH resource, PUSCH allocation, or PUSCH occasion. Similarly, PUCCH may be replaced with PUCCH transmission, PUCCH resource, PUCCH allocation, or PUCCH occasion.

### (First Aspect)

In a first aspect, a UE operation in the case in which simultaneous transmission of PUCCH/PUSCH (the function 4) is applied in UL collision handling framework is explained. Note that application may be replaced with enabling/activating/setting. The PUCCH and the PUSCH transmitted simultaneously may have the same priority or different priorities.

A UE may resolve overlap using a plurality of steps (or functions) in at least one of a case in which a plurality of UL transmissions having the same priority overlap and a case in which a plurality of UL transmissions having different priorities overlap. In such a case, the UE may control application of the simultaneous transmission of the PUCCHs/PUSCHs in at least one of the plurality of steps (or functions).

When the function 4 is applied in the UL collision handling framework, at least one of the following options 1-1 to 1-2 may be applied.

### <Option 1-1>

The function 4 may be configured to be associated only with an existing system (for example, the function of Rel. 16). That is, the function 4 may be associated with the function 1 (for example, the function 1-2)/the function 2.

Considering that the purpose of the function 4 is to resolve a conflict of PUCCH and PUSCH, it is necessary to control whether the function 1-2 (multiplexing of UCI/PUSCH having the same priority) supported in Rel. 16 functions. For example, at least one of the following options 1-1-1 to 1-1-2 may be applied.

### <<Option 1-1-1>>

the function 1-2 supported in Rel. 16 may be supported to operate together with function 4. In this case, the function 1-1, the function 1-2, the function 2, and the function 4 may be applied as functions of the framework of the UL collision handling.
Function 1-1: Multiplexing of PUCCHs having the same priority
Function 1-2: Multiplexing of PUCCHs/PUSCHs having the same priority
Function 2: Prioritization among different priorities
Function 4: Simultaneous transmission of PUCCH/PUSCH

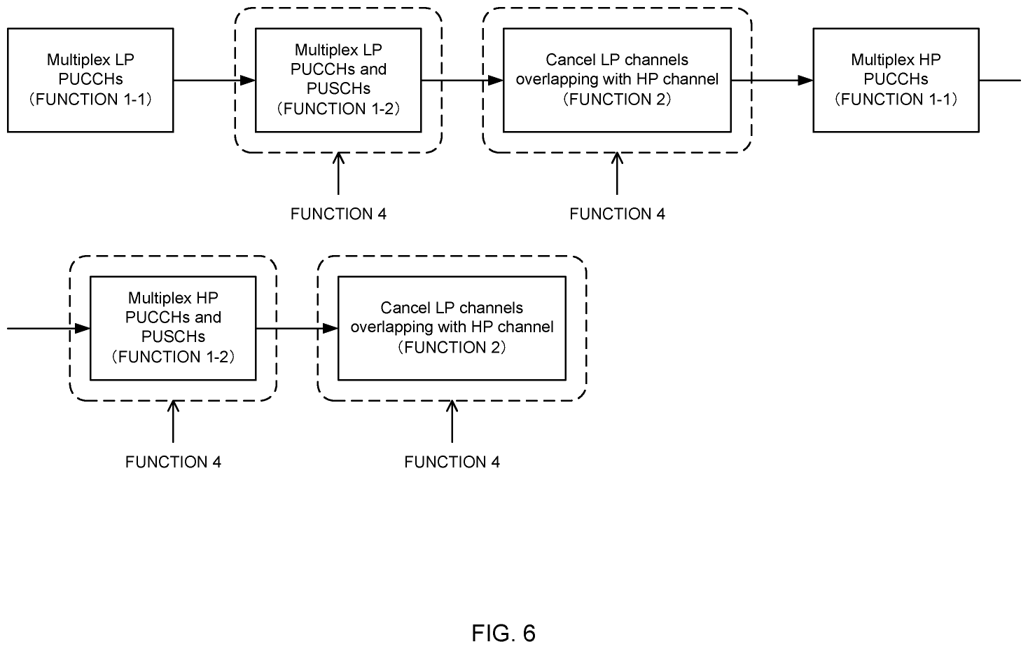

Based on the Rel. 16 collision handling framework, for any step having the function 1-2/the function 2, the function 4 may or may not be applied (see FIG. 6). FIG. 6 illustrates a case in which application of the function 4 is supported for any step having the function 1-2/the function 2.

Whether to apply the function 4 and in which step the function 4 is applied may be defined in the specifications, may be set by higher layer signaling, or may be determined based on a timeline condition (for example, timeline condition checking).

### [Interaction Between the Function 2 and the Function 4]

In the function 2, an interaction is conceivable between the function 2 and the function 4 for collision of PUCCHs/PUSCHs of HP and LP. When a simultaneous transmission condition for PUCCHs/PUSCHs is satisfied in a collision case, a colliding LP channel may not be dropped (simultaneous transmission of PUCCH/PUSCH is performed). Otherwise, the colliding LP channel may be dropped.

### [Interaction Between the Function 1-2 and the Function 4]

For the interaction between the function 1-2 and the function 4, the function 1-2 may be applied before the function 4 or the function 1-2 may be applied after the function 4.

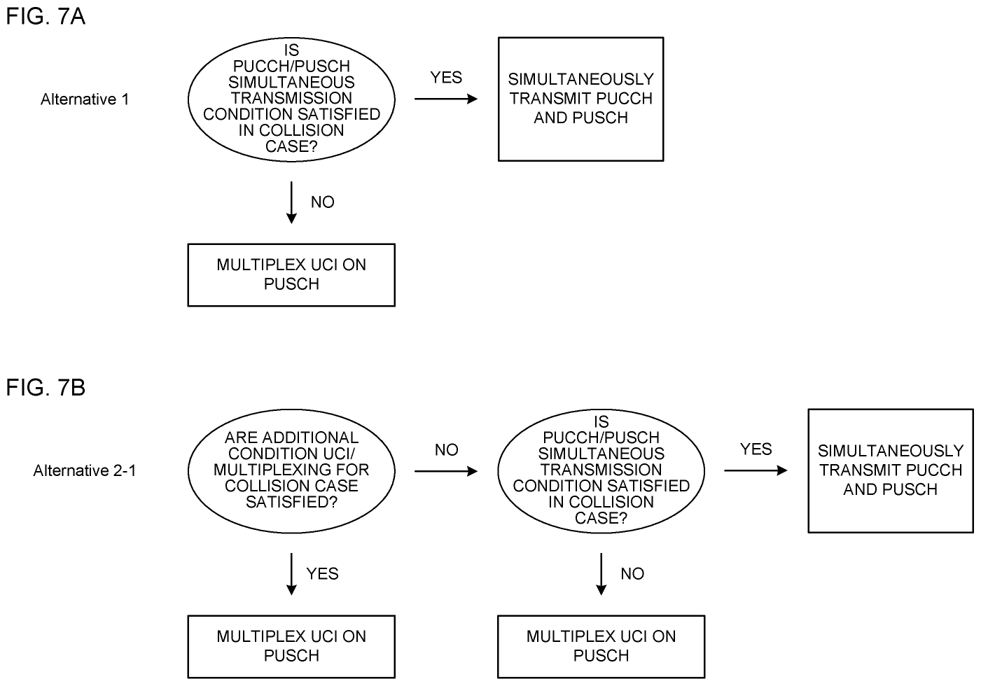

It is assumed that the function 4 is applied before the function 1-2. When the simultaneous transmission of PUCCH/PUSCH satisfies a given condition (for example, is satisfied for a collision case), the PUSCH and the PUCCH may not be multiplexed. Otherwise, UCI may be multiplexed on the PUSCH (see FIG. 7A). The given condition may be defined in the specifications or may be set by the higher layer signaling. Alternatively, presence or absence of application of simultaneous transmission of PUCCH/PUSCH in the collision case from the base station to the UE (for example, activation/deactivation or enabling/disabling) may be set.

It is assumed that the function 1-2 is applied before the function 4. Note that, in Rel. 16, conditions other than the timeline are not defined for multiplexing of UCI/PUSCH having the same priority. In this case, a condition for determining whether the UCI is multiplexed on the PUSCH or the UCI is transmitted on the PUCCH simultaneously with the PUSCH (or the UCI is multiplexed on the PUCCH transmitted simultaneously with the PUSCH) may be additionally defined.

For example, when an additional condition is satisfied, the UCI may be multiplexed on the PUSCH and the colliding PUCCH may not be transmitted (see FIG. 7B). Otherwise, the transmission may be controlled based on a condition of the simultaneous transmission of the PUCCHs/PUSCHs. The condition of the simultaneous transmission of the PUCCHs/PUSCHs may be defined in the specifications or enabling/disabling of the simultaneous transmission of PUCCH/PUSCH may be set from the base station.

When the condition of the simultaneous transmission of the PUCCHs/PUSCHs is satisfied for the collision case, the simultaneous transmission of the PUCCHs/PUSCHs may be performed. Otherwise, the operation returns to the operation of PUCCHs/PUSCHs multiplexing (the UCI is multiplexed on the PUSCH).

The additional condition may be determined based on a condition (for example, the length of the PUCCH and the length of the PUSCH) based on a viewpoint of reliability or may be determined based on a condition (for example, end symbols of the PUCCH and the PUSCH) based on a viewpoint of delay.

Alternatively, the additional condition regarding multiplexing of UCI/PUSCH may not be defined. In this case, the UCI may be always multiplexed on the PUSCH and the PUSCH may not be transmitted.

### <<Option 1-1-2>>

The function 1-2 supported in Rel. 16 may be configured not to be applied in the framework of the UL collision handling when the function 4 is applied/enabled. In this case, the function 1-1, the function 2, and the function 4 may be applied as the functions of the framework of the UL collision handling.
Function 1-1: Multiplexing of PUCCHs having the same priority
Function 2: Prioritization among different priorities
Function 4: Simultaneous transmission of PUCCH/PUSCH

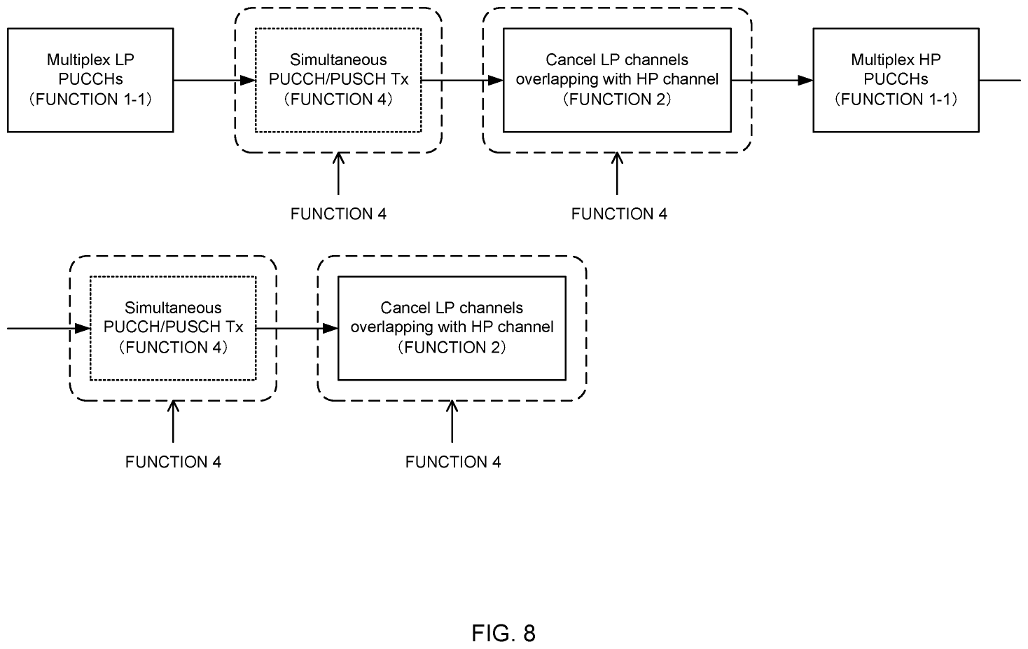

Based on the Rel. 16 collision handling framework, when the function 4 is applied, the function 1-2 may be controlled not to be applied (for example, the function 1-2 and the function 4 may be interchanged). The function 4 may or may not be applied to a given step having the function 2 (see FIG. 8). FIG. 8 illustrates a case in which application of the function 4 is supported for any step having the function 2.

In the function 4, the simultaneous transmission of PUCCH/PUSCH may be applied when a given condition is satisfied for the collision case. Otherwise, the PUCCH or the PUSCH may be dropped. In the function 2, for the PUCCHs/PUSCHs collision between the HP and the LP, the interaction between the function 2 and the function 4 explained in the option 1-1-1 may be applied to the interaction between the function 2 and the function 4.

Since UCI/PUSCH multiplexing is not applied in the option 1-2, PUCCHs/PUSCHs simultaneous transmission or channel cancellation may be performed because of the PUCCHs/PUSCHs collision.

### <Option 1-2>

The function 4 may be configured to be associated with both the functions of Rel. 16 and Rel. 17 and subsequent functions. That is, the function 4 may be associated with the function 1 (for example, the function 1-2)/the function 2/the function 3-1/the function 3-2. In this case, at least one of the following options 1-2-1 to 1-2-3 may be applied.

### <<Option 1-2-1>>

The function 1-2 (multiplexing of UCI/PUSCH having the same priority) and the function 3-2 multiplexing of (UCI/PUSCH having different priorities) may be supported to work together with simultaneous transmission of PUCCH/PUSCH. In this case, the function 1-1, the function 1-2, the function 2, the function 3-1, the function 3-2, and the function 4 may be applied as the functions of the framework of the UL collision handling.
Function 1-1: Multiplexing of PUCCHs having the same priority
Function 1-2: Multiplexing of PUCCHs/PUSCHs having the same priority
Function 2: Prioritization among different priorities
Function 3-1: Multiplexing of PUCCHs having different priorities
Function 3-2: Multiplexing of PUCCHs/PUSCHs having different priorities
Function 4: Simultaneous transmission of PUCCH/PUSCH

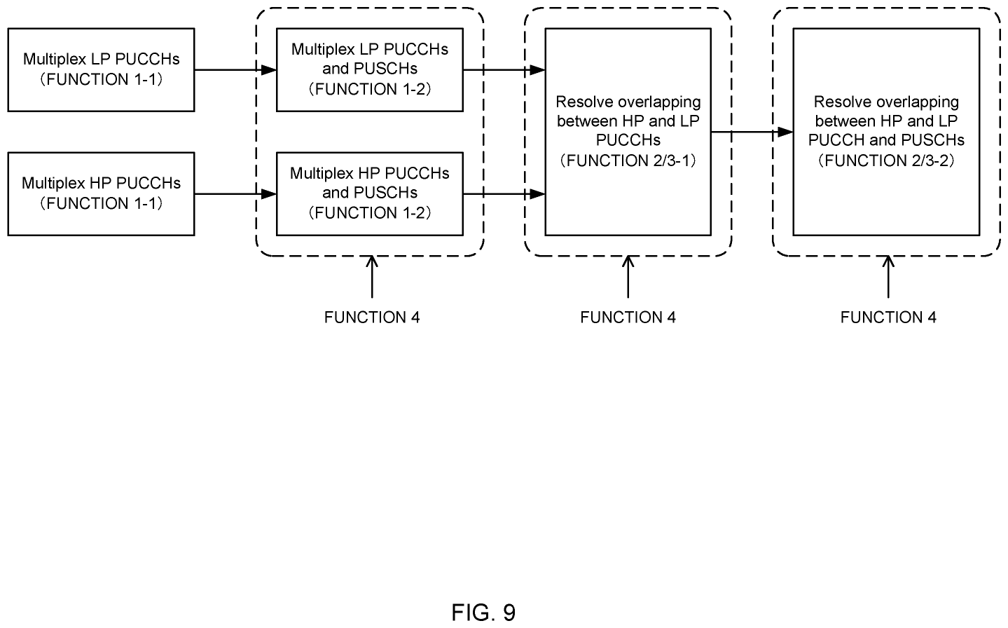

In the UL collision handling framework after Rel. 17, the function 4 may or may not be applied in a given step for solving the PUCCHs/PUSCHs overlap (see FIG. 9). The presence or absence of application of the function 4 and the step of applying the function 4 (in which step the function 4 is applied) may be defined in the specifications, may be set by higher layer signaling, or may be determined based on a condition of a timeline (for example, timeline condition checking).

When application of the function 4 is supported in the function 1-2, an interaction is conceivable between the function 1-2 and the function 4. For the interaction between the function 1-2 and the function 4, the interaction between the function 1-2 and the function 4 explained in the option 1-1-1 may be applied.

In the function 2, an interaction between the function 2 and the function 4 is conceivable for PUCCHs/PUSCHs collision between HP and LP. In this case, the interaction between the function 2 and the function 4 explained in the option 1-1-1 may be applied.

### [Interaction Between the Function 3-2 and the Function 4]

When the application of function 4 is supported in the function 3-2, an interaction is conceivable between the function 3-2 and the function 4.

For the interaction between the function 3-2 and the function 4, the function 3-2 may be applied before the function 4 or the function 3-2 may be applied after the function 4.
[[Case in which the Function 4 is Applied Before the Function 3-2]]

It is assumed that the function 4 is applied before the function 3-2. In this case, multiplexing for partial UCI and simultaneous transmission of PUCCH/PUSCH for the partial UCI may not be allowed. The partial UCI may be a part of UCI (for example, at least one of HARQ-ACK, CSI, and SR).

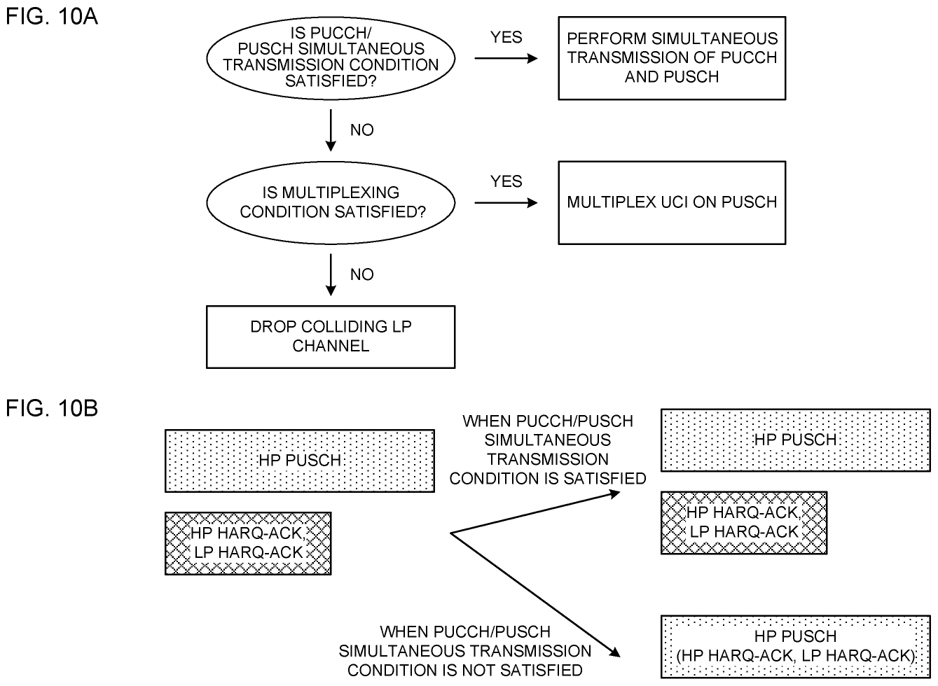

For example, when a condition for simultaneous transmission of PUCCH/PUSCH is satisfied for a collision case, the PUSCH and the PUCCH may be simultaneously transmitted (see FIG. 10A). Otherwise, multiplexing UCI of the PUCCH on the PUSCH may be supported/enabled and the UCI may be multiplexed into the PUSCH when a multiplexing condition (for example, multiplexing condition) is satisfied in the collision case. Otherwise, a colliding LP channel may be dropped.

It is assumed that HP_PUSCH and HP_HARQ-ACK/LP_HARQ-ACK overlap. In such a case, when the condition for the simultaneous transmission of the PUCCHs/PUSCHs is satisfied, the HP_PUSCH and PUCCH including the HP_HARQ-ACK/LP_HARQ-ACK may be simultaneously transmitted (see FIG. 10B). On the other hand, when the condition for the simultaneous transmission of the PUCCHs/PUSCHs is not satisfied, whether UCI (here, HP_HARQ-ACK/LP_HARQ-ACK) is multiplexed on the PUSCH may be determined based on the multiplexing condition.

Alternatively, multiplexing on the partial UCI and simultaneous transmission of the PUCCHs/PUSCHs for the partial UCI may be allowed (or supported). For example, when the HP_PUSCH and a plurality of UCIs overlap, a part of of UCIs may be multiplexed on the HP_PUSCH and other UCIs may be simultaneously transmitted with the HP_PUSCH by using the PUCCH.

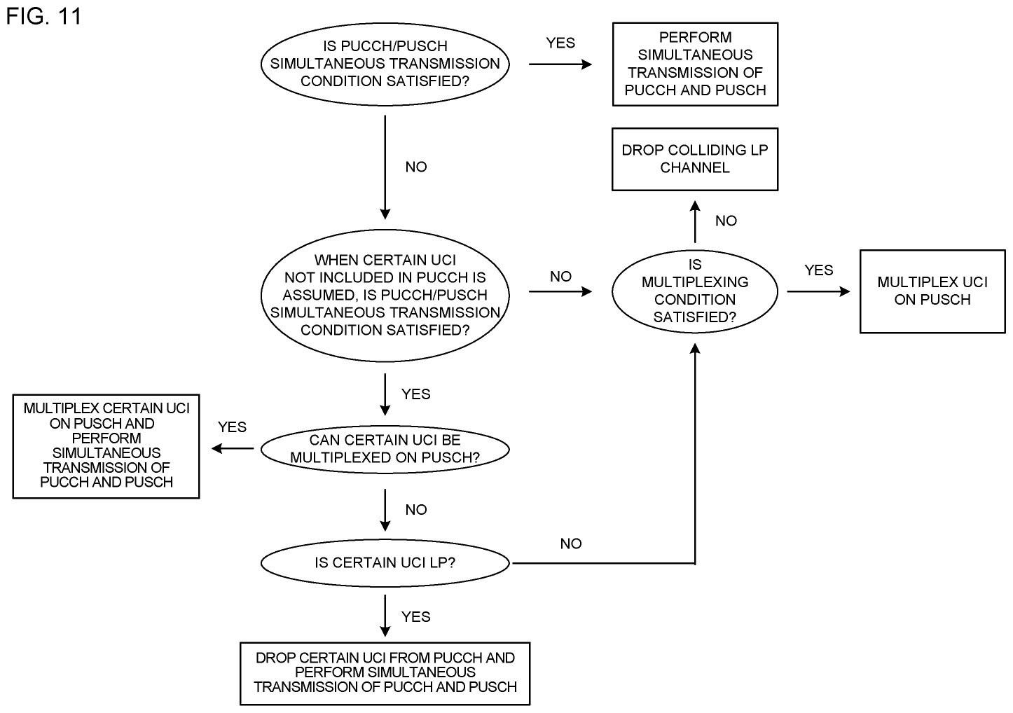

Specifically, when the condition for the simultaneous transmission of the PUCCHs/PUSCHs is satisfied for the collision case, the PUSCH and the PUCCH may be simultaneously transmitted (see FIG. 11). In other cases, when certain UCI not included in the PUCCH is assumed, when the condition for the simultaneous transmission of the PUCCHs/PUSCHs is satisfied and the certain UCI can be multiplexed with any PUSCH, the certain UCI may be multiplexed on the PUSCH. Simultaneous transmission of the PUCCHs/PUSCHs may be performed.

Otherwise (for example, when certain UCI cannot be multiplexed on the PUSCH) and the certain UCI is LP, the UCI may be dropped to perform the simultaneous transmission of the PUCCH and the PUSCH. Otherwise (for example, when certain UCI is not LP), the check/determination of the multiplexing condition may be performed again.

Otherwise (for example, when the condition for the simultaneous transmission of the PUCCHs/PUSCHs is not satisfied for the collision case), when multiplexing of UCI in the PUCCH on the PUSCH is supported/enabled and the multiplexing condition is satisfied for the collision case, the UCI may be multiplexed on the PUSCH. Otherwise (for example, when the multiplexing condition is not satisfied), a colliding LP channel may be dropped.

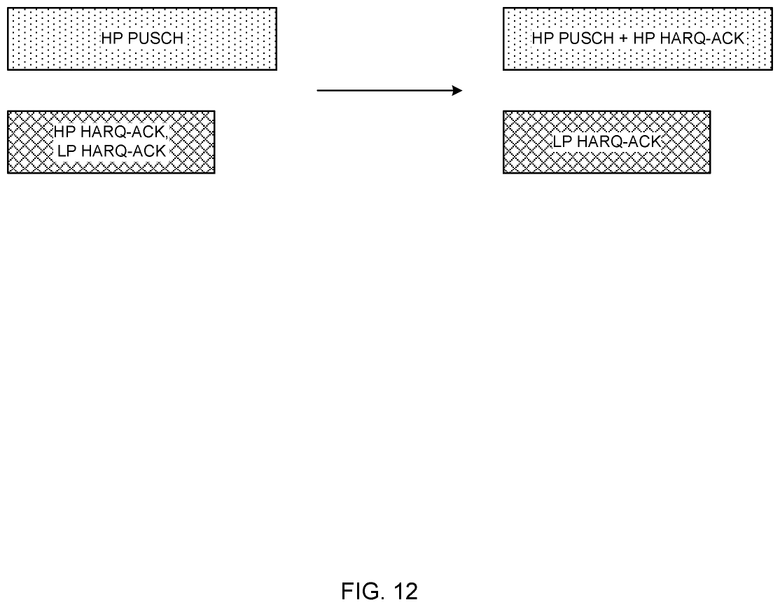

It is assumed that HP_PUSCH and HP_HARQ-ACK/LP_HARQ-ACK overlap. In such a case, a case is explained in which the simultaneous transmission condition for the PUCCHs/PUSCHs is supported/enabled for “HP PUSCH vs. LP PUCCH (with LP UCI)”. On the other hand, a case is explained in which the simultaneous transmission condition for the PUCCHs/PUSCHs is not supported for “HP PUSCH vs. PUCCH with both HP and LP UCI”. In this case, the HP HARQ-ACK may be multiplexed on the HP PUSCH and the PUSCH and PUCCH including the LP HARQ-ACK may be simultaneously transmitted (see FIG. 12).

[[Case in which the Function 3-2 is Applied Before the Function 4]]

It is assumed that the function 3-2 is applied before the function 4. In this case, at least one of the following cases 1-1 to 1-3 may be applied.

### —Case 1-1

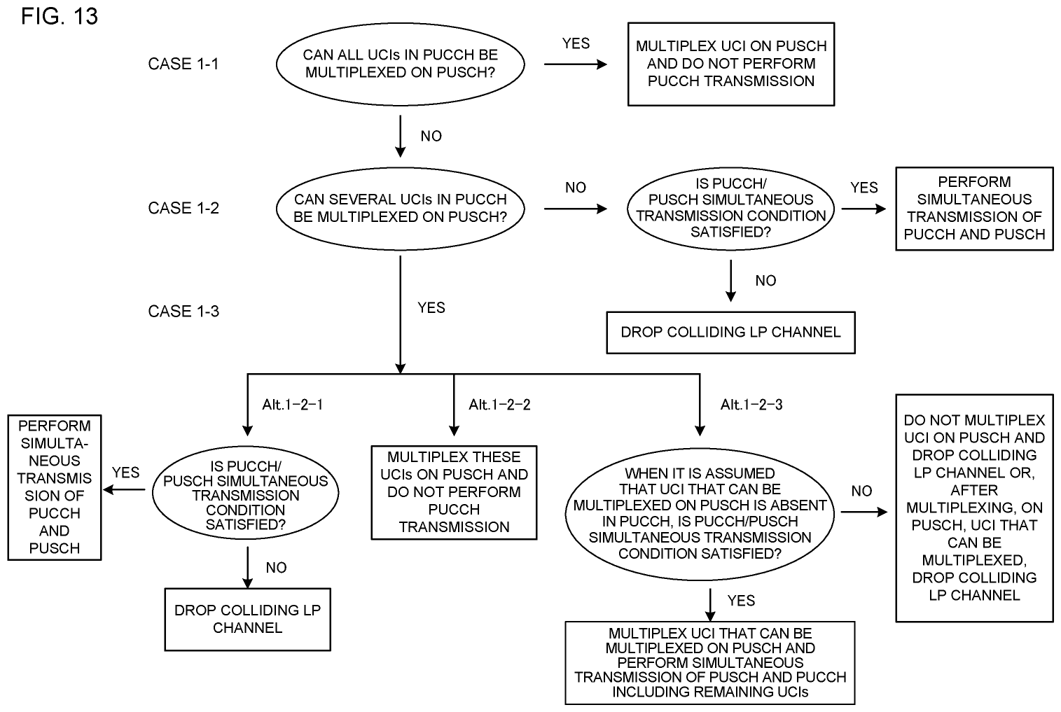

For a collision case, it is assumed that multiplexing of all UCIs in PUCCH on the PUCCH is supported/enabled and a multiplexing condition is satisfied for the current collision case. In such a case, control may be performed to multiplex the UCI on the PUSCH and not to transmit the PUCCH (see FIG. 13).

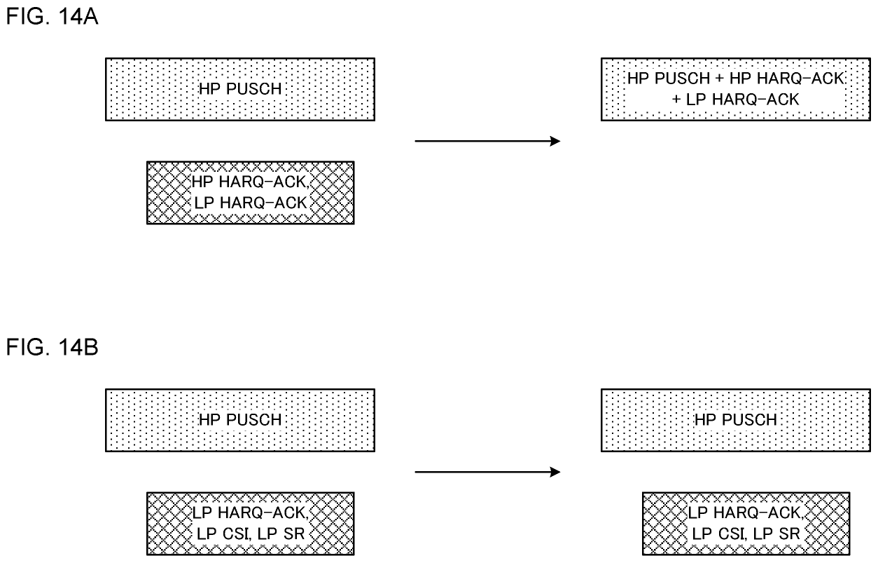

For example, it is assumed that HP_PUSCH and HP_HARQ-ACK/LP_HARQ-ACK overlap and LP_HARQ-ACK multiplexed on the HP_PUSCH is valid. In such a case, HP_HARQ-ACK/LP_HARQ-ACK may be multiplexed on the PUSCH and control may be performed not to transmit the PUCCH (see FIG. 14A).

### —Case 1-2

For a collision case, it is assumed that several UCIs in the PUCCH cannot be multiplexed on the PUSCH. In such a case, a condition for simultaneous transmission of PUCCH/PUSCH may be checked (for example, transmission may be controlled based on the condition for the simultaneous transmission of the PUCCHs/PUSCHs) (see FIG. 13). When the condition for the simultaneous transmission of the PUCCHs/PUSCHs is satisfied, simultaneous transmission of the PUSCH and the PUCCH may be performed. Otherwise, a colliding LP channel may be dropped.

For example, it is assumed that HP_PUSCH and LP_HARQ-ACK/LP_CSI/LP_SR overlap and multiplexing of LP_UCI in HP_PUSCH is not enabled (not supported). In such a case, transmission may be controlled based on the condition for the simultaneous transmission of the PUCCHs/PUSCHs. When the condition for the simultaneous transmission of the PUCCHs/PUSCHs is satisfied, HP_PUSCH and PUCCH including LP_HARQ-ACK/LP_CSI/LP_SR may be simultaneously transmitted (see FIG. 14 B).

### —Case 1-3

For a collision case, it is assumed that certain UCI (or some/a part of UCI) in PUCCH is supported/enabled to be multiplexed on PUSCH and the other UCIs cannot be multiplexed on the PUSCH. In such a case, at least one of the following Alt. 1-2-1 to Alt. 1-2-3 may be applied.

### <<Alt. 1-2-1>>

UCI multiplexing on PUSCH may not be performed (see FIG. 13). In this case, a condition for simultaneous transmission of PUCCH/PUSCH is confirmed. When the condition for the simultaneous transmission of the PUCCHs/PUSCHs is satisfied, simultaneous transmission of the PUSCH and the PUCCH may be performed. Otherwise, a colliding LP channel may be dropped.

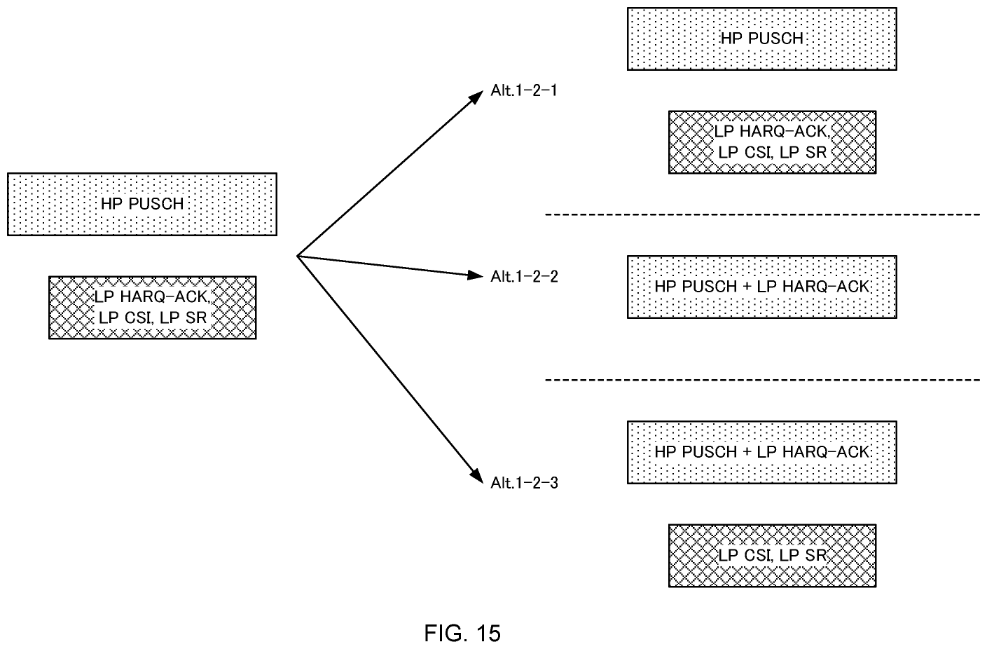

For example, it is assumed that HP_PUSCH and LP_HARQ-ACK/LP_CSI/LP_SR overlap and multiplexing of LP_UCI in HP_PUSCH is enabled (or supported). It is assumed that the multiplexing of the LP_CSI and the LP_SR in HP_PUSCH is disabled (or not supported). In such a case, when UCI is not multiplexed on the PUSCH and the condition for the simultaneous transmission of the PUCCHs/PUSCHs is satisfied, the simultaneous transmission of the PUSCH and the PUCCH may be performed (see FIG. 15).

### <<Alt. 1-2-2>>

For partial UCI, UCI may be multiplexed on PUSCH without confirming simultaneous transmission of PUCCH/PUSCH (or, the simultaneous transmission of the PUCCHs/PUSCHs is not applied). One or a plurality of UCIs that can be multiplexed on the PUSCH may be multiplexed on the PUSCH and control may be performed not to transmit the PUCCH.

For example, it is assumed that HP_PUSCH and LP_HARQ-ACK/LP_CSI/LP_SR overlap and multiplexing of LP_UCI in HP_PUSCH is enabled (or supported). It is assumed that the multiplexing of the LP_CSI and the LP_SR in HP_PUSCH is disabled (or not supported). In such a case, the simultaneous transmission of the PUCCHs/PUSCHs may not be performed and a part of UCI (for example, LP_HARQ-ACK) may be multiplexed on the PUSCH (see FIG. 15).

### <<Alt. 1-2-3>>

UCI multiplexing on PUSCH may be performed for partial UCI and simultaneous PUCCHs/PUSCHs transmission may be confirmed for PUCCH having only other UCIs. In this case, assuming the remaining UCIs that cannot be multiplexed on the PUCCH, a condition of simultaneous transmission of PUCCH/PUSCH may be confirmed.

When it is assumed that UCI that can be multiplexed on the PUSCH is absent in the PUCCH and the condition for the simultaneous transmission of the PUCCHs/PUSCHs is satisfied, UCI can be multiplexed may be multiplexed on the PUSCH. The PUSCH and PUCCH including the remaining UCIs may be simultaneously transmitted. Otherwise, colliding LP channel may be dropped without multiplexing UCI on the PUSCH or the colliding LP channel may be dropped after multiplexing UCI that can be multiplexed is multiplexed on the PUSCH.

For example, it is assumed that HP_PUSCH and LP_HARQ-ACK/LP_CSI/LP_SR overlap and multiplexing of LP_UCI in HP_PUSCH is enabled (or supported). It is assumed that the multiplexing of the LP_CSI and the LP_SR in HP_PUSCH is disabled (or not supported). In such a case, when it is assumed that UCI that can be multiplexed on the PUSCH is absent in the PUCCH and the condition for the simultaneous transmission of the PUCCHs/PUSCHs is satisfied, UCI that can be multiplexed (for example, LP_HARQ-ACK) may be multiplexed on the PUSCH. The PUSCH and PUCCH including the remaining UCIs (for example, LP_CSI/LP_SR) may be simultaneously transmitted (see FIG. 15).

### <<Option 1-2-2>>

The function 1-2 (multiplexing of UCI/PUSCH having the same priority) may be supported to operate together with the simultaneous transmission of the PUCCHs/PUSCHs. The function 3-2 (multiplexing of UCI/PUSCH having different priorities) may be configured not to be used together with the simultaneous transmission of the PUCCHs/PUSCHs. In this case, the function 1-1, the unction 1-2, the function 2, the function 3-1, and the function 4 may be applied as the functions of the framework of the UL collision handling. A mutual relationship between the functions (for example, the function 4 and the function 1-2/the function 2/the function 3-1) may be controlled based on the contents indicated by other options.

### <<Option 1-2-3>>

The function 1-2 (multiplexing of UCI/PUSCH having the same priority) and the function 3-2 (multiplexing of UCI/PUSCH having different priorities) may be configured not to be supported (not to be used) to operate together with the simultaneous transmission of the PUCCHs/PUSCHs. In this case, the function 1-1, the function 2, the function 3-1, and the function 4 may be applied as the functions of the framework of the UL collision handling. A mutual relationship between the functions (for example, the function 4 and the function 2/the function 3-1) may be controlled based on the contents indicated by other options.

As explained above, by appropriately controlling the steps to which the PUCCHs/PUSCHs simultaneous transmission (the function 4) is applied and the mutual relation with the other functions, when a plurality of UL transmissions overlap, it is possible to resolve the overlap. As a result, even when a new function (for example, the PUCCHs/PUSCHs simultaneous transmission (the function 4)) is supported/introduced in the UL collision handling framework, UL transmission can be appropriately controlled.

### (Second Aspect)

In a second aspect, in the UL collision handling framework, order of multiplexing and simultaneous transmission, and a timeline requirement in a case in which given multiplexing (for example, the function 1-2/the function 3-2) is supported to operate together with the function 4 are explained. Note that the case in which the given multiplexing (for example, the function 1-2/the function 3-2) operates together with the function 4 may be, for example, the option 1-1-1/1-2-1/1-2-2 of the first aspect.

### <Application Order of Multiplexing and Simultaneous Transmission>

When given multiplexing (for example, the function 1-2/the function 3-2) is supported to operate together with the function 4, at least one of the following options 2-1-1 to 2-1-2 may be applied as application order of multiplexing of PUCCH (UCI)/PUSCH and simultaneous transmission of PUCCH/PUSCH.

### <<Option 2-1-1>>

PUCCH (UCI)/PUSCH multiplexing may be performed before application/check/determination of the simultaneous transmission of the PUCCHs/PUSCHs. For example, the function 1-2/the function 3-2 may be applied before the function 4. Consequently, transmission using the PUSCH can be prioritized for UCI that can be multiplexed on the PUSCH.

### <<Option 2-1-2>>

The simultaneous transmission of the PUCCHs/PUSCHs may be performed before the PUCCH (UCI)/PUSCH multiplexing. For example, the function 1-2/the function 3-2 may be applied after the function 4. In this case, the PUCCH can be preferentially used as a channel used for transmission of the UCI.

### <Timeline Request>

When given multiplexing (for example, the function 1-2/the function 3-2) is supported to operate together with the function 4, at least one of the following options 2-2-1 to 2-2-2 may be applied to a timeline request. Note that the following options 2-2-1 to 2-2-2 may be applied when different timeline requests are defined for the simultaneous transmission of the PUCCHs/PUSCHs (for example, the function 4) and the multiplexing of the PUCCHs/PUSCHs (for example, the function 1-2/the function 3-2).

### <<Option 2-2-1>>

A strictest timeline (for example, most stringent timeline) may be requested. For example, when a timeline corresponding to the simultaneous transmission of the PUCCHs/PUSCHs and a timeline corresponding to the multiplexing of the PUCCHs/PUSCHs are separately defined/set, the functions may be applied when the strictest (for example, shortest period) timeline is satisfied.

When timelines respectively corresponding to a plurality of functions (for example, two functions) are satisfied, a UE may apply the functions. On the other hand, when at least one timeline is not satisfied, the UE may perform control not to apply the functions (or not to apply a part of the functions).

When a timeline condition is not satisfied, this may be determined as an error case.

### <<Option 2-2-2>>

A mildest timeline (for example, most relaxed timeline) may be requested.

When the strictest timeline (for example, most stringent timeline) condition is satisfied, all of a plurality of functions (for example, the function 4, the function 1-2/the function 3-2) may be applied.

When a timeline condition is satisfied for a certain function but timeline conditions are not satisfied for the other functions, only the function corresponding to the satisfied timeline condition may be applied. On the other hand, a function for which timeline is not satisfied may not be applied. When the UE applies/concurretly uses a certain function (for example, the function 4) and the other functions (for example, the function 1-2/the function 2/3-2) in the UL collision handling framework, the UE may determine application presence or absence/application order of the functions based on timelines corresponding to the functions.

When the timelines are not satisfied for all the functions, this may be determined as an error case.

### (Third Aspect)

In a third aspect, a UE operation in the case in which the simultaneous transmission of the PUCCHs/PUSCHs is performed in the UL collision handling framework is explained.

In the UL collision handling framework, when the simultaneous transmission of the PUCCHs/PUSCHs is performed, multiplexing of the PUCCH (UCI)/PUSCH is likely to be affected.

When it is determined that the PUCCH collides with a plurality of PUSCHs and multiplexing is performed, a case occurs in which PUSCH for which UCI multiplexing is performed is selected.

In such a case, when PUSCH satisfying the condition for simultaneous transmission with the PUCCH is absent, the a PUSCH selection rule may be determined/decided based on a given condition. The given condition may be a PUSCH (or PUSCH occasion) allocation position or a PUSCH type.

For example, when an overlapping plurality of PUSCHs are present in a plurality of slots, a head PUSCH may be selected. Alternatively, when am overlapping plurality of PUSCHs are present in the same slot, PUSCH may be selected based on types of the PUSCHs. The type of the PUSCH may be dynamic grant PUSCH (DG PUSCH) or set grant PUSCH (CG PUSCH). For example, the DG PUSCH may be preferentially selected.

Alternatively, in a case in which a PUSCH is selected, when a PUSCH satisfying the condition for the simultaneous transmission with the PUCCH is present (however, when the condition of the PUCCHs/PUSCHs simultaneous transmission cannot be satisfied because a certain PUSCH cannot satisfy the condition), at least one of the following options 3-1 to 3-2 may be applied as the PUSCH selection rule.

### <Option 3-1>

One or more PUSCHs that can be simultaneously transmitted with the PUCCH may be excluded first before PUSCH selection for performing UCI multiplexing (for example, multiplexed PUSCH selection). Thereafter, the PUSCH for which the UCI multiplexing is performed may be selected out of the remaining PUSCHs based on a given condition.

### <Option 3-2>

One or more PUSCHs that can be simultaneously transmitted with the PUCCH may not be excluded before the PUSCH selection for performing the UCI multiplexing (for example, multiplexed PUSCH selection). The PUSCH for performing the UCI multiplexing may be selected based on a given condition considering all colliding PUSCHs. This may mean that, even if the selected PUSCH can be transmitted simultaneously with the PUCCH, the UCI is multiplexed on the PUSCH.

(Simultaneous transmission condition for PUCCHs/PUSCHs) How to support/enable the simultaneous transmission of the PUCCHs/PUSCHs may be determined based on at least one of a priority of PUCCHs/PUSCHs (for example, a PHY priority), a UCI type, multiplexing of UCI, and inter-band/intra-band CA.

A condition for the simultaneous transmission of the PUCCHs/PUSCHs for a collision case may be determined based on the PUSCHs overlapping the PUCCH. For example, when at least one PUSCH on any CC cannot be simultaneously transmitted with the PUCCH, it may be determined that the PUCCHs/PUSCHs simultaneous transmission condition is not satisfied.

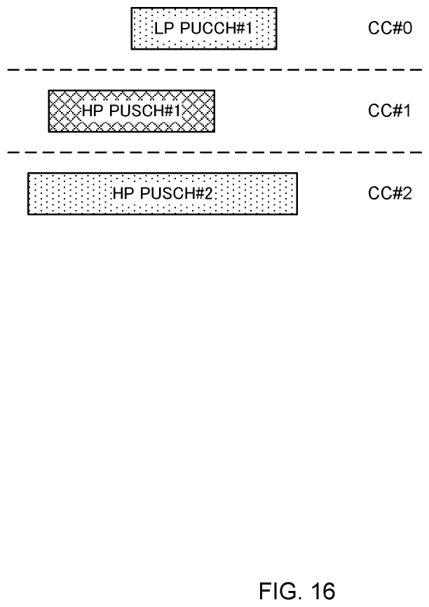

For example, it is assumed that simultaneous transmission with the PUCCH in CC #0 is supported/enabled in HP_PUSCH #1 of CC #1 but is not supported/enabled in HP_PUSCH #2 of CC #2 (see FIG. 16). In such a case, LP_PUCCH #1 may not be transmitted simultaneously with the PUSCH. In this case, the LP_PUCCH may be multiplexed on the PUSCH or dropped.

### <UE Capability Information>

In the first aspect to the third aspect, the following UE capabilities (UE capabilities) may be set. Note that the following UE capabilities may be replaced with parameters (for example, higher layer parameters) set for a UE from a network (for example, a base station).

UE capability information regarding whether to support the simultaneous transmission of the PUCCHs/PUSCHs may be defined.

UE capability information regarding whether to support the simultaneous transmission of the PUCCHs/PUSCHs operating together with Rel. 16 multiplexing for the same priority may be defined.

UE capability information regarding whether to support the simultaneous transmission of the PUCCHs/PUSCHs operating together with Rel. 17 or later multiplexing for different priorities may be defined.

UE capability information regarding whether to support confirmation (or check/determination) function for the simultaneous transmission of the PUCCHs/PUSCHs before UCI/PUSCH multiplexing may be defined.

UE capability information regarding whether to support UCI/PUSCH multiplexing before confirmation of the simultaneous transmission of the PUCCHs/PUSCHs may be defined.

The first aspect to the third aspect may be configured to be applied to a UE that supports/reports at least one of the UE capabilities explained above. Alternatively, the first aspect to the third aspect may be configured to be applied to a UE set from a network.

Note that which of the control methods explained in at least one of the first aspect to the third aspect is applied may be notified/set to the UE by a higher layer parameter. Alternatively, the UE may report as capability information (for example, UE capability).

### (Radio Communication System)

In the following explanation, a configuration of a radio communication system according to one embodiment of the present disclosure is explained. In this radio communication system, communication is performed using one or a combination of the radio communication methods according to the embodiments of the present disclosure.

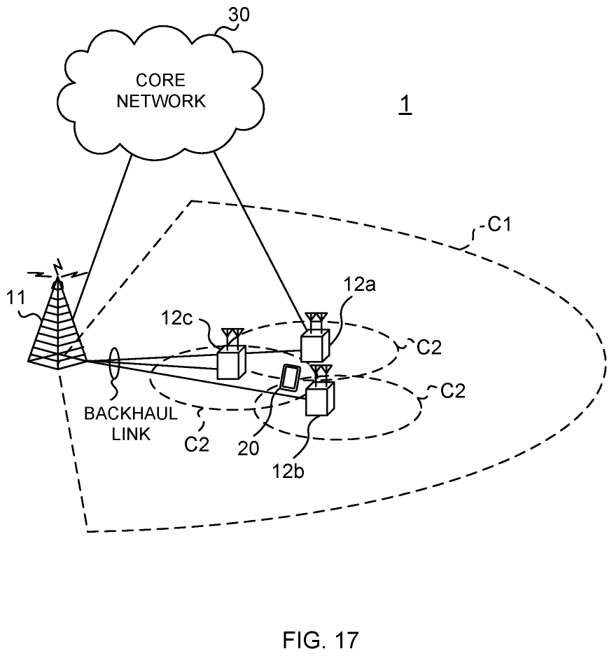

FIG. 17 is a diagram illustrating an example of a schematic configuration of the radio communication system according to one embodiment. A radio communication system 1 may be a system that implements communication using long term evolution (LTE), 5th generation mobile communication system New Radio (5G NR), and the like drafted as the specification by third generation partnership project (3GPP).

The radio communication system 1 may support dual connectivity between a plurality of radio access technologies (RATs) (multi-RAT dual connectivity (MR-DC)). The MR-DC may include dual connectivity between LTE (evolved universal terrestrial radio access (E-UTRA)) and NR (E-UTRA-NR dual connectivity (EN-DC)), dual connectivity between NR and LTE (NR-E-UTRA dual connectivity (NE-DC)), and the like.

In the EN-DC, an LTE (E-UTRA) base station (eNB) is a master node (MN), and an NR base station (gNB) is a secondary node (SN). In the NE-DC, an NR base station (gNB) is MN, and an LTE (E-UTRA) base station (eNB) is SN.

The radio communication system 1 may support dual connectivity between a plurality of base stations in the same RAT (for example, dual connectivity in which both MN and SN are NR base stations (gNB) (NR-NR dual connectivity (NN-DC)).

The radio communication system 1 may include a base station 11 that forms a macro cell C1 with a relatively wide coverage, and base stations 12 (12a to 12c) that are arranged in the macro cell C1 and that form small cells C2 narrower than the macro cell C1. A user terminal 20 may be positioned in at least one cell. The arrangement, number, and the like of cells and the user terminals 20 are not limited to the aspects illustrated in the drawings. In the following explanation, the base stations 11 and 12 are collectively referred to as “base stations 10”, unless these are distinguished from each other.

The user terminal 20 may be connected to at least one of the plurality of base stations 10. The user terminal 20 may use at least one of carrier aggregation (CA) using a plurality of component carriers (CC) and dual connectivity (DC).

Each CC may be included in at least one of a first frequency range 1 (FR1) and a second frequency range 2 (FR2). The macro cell C1 may be included in FR1, and the small cell C2 may be included in FR2. For example, FR1 may be a frequency range of 6 GHz or less (sub-6 GHZ), and FR2 may be a frequency range higher than 24 GHZ (above-24 GHZ). Note that the frequency ranges, definitions, and the like of the FR1 and FR2 are not limited thereto, and, for example, FR1 may correspond to a frequency range higher than FR2.

The user terminal 20 may perform communication on each CC using at least one of time division duplex (TDD) or frequency division duplex (FDD).

The plurality of base stations 10 may be connected to each other in a wired manner (for example, an optical fiber, an X2 interface, or the like in compliance with common public radio interface (CPRI)) or in a wireless manner (for example, NR communication). For example, when NR communication is used as a backhaul between the base stations 11 and 12, the base station 11 corresponding to a higher-level station may be referred to as an integrated access backhaul (IAB) donor, and the base station 12 corresponding to a relay station (relay) may be referred to as an IAB node.

The base station 10 may be connected to a core network 30 via another base station 10 or directly. The core network 30 may include, for example, at least one of evolved packet core (EPC), 5G core network (5GCN), next generation core (NGC), or the like.

The user terminal 20 may be a terminal corresponding to at least one of communication methods such as LTE, LTE-A, and 5G.

In the radio communication system 1, a radio access method based on orthogonal frequency division multiplexing (OFDM) may be used. For example, in at least one of downlink (DL) or uplink (UL), cyclic prefix OFDM (CP-OFDM), discrete Fourier transform spread OFDM (DFT-s-OFDM), orthogonal frequency division multiple access (OFDMA), single carrier frequency division multiple access (SC-FDMA), and the like may be used.

The radio access method may be referred to as a waveform. Note that, in the radio communication system 1, another radio access method (for example, another single carrier transmission method or another multi-carrier transmission method) may be used as the UL and DL radio access methods.

In the radio communication system 1, a downlink shared channel (physical downlink shared channel (PDSCH)) shared by the user terminals 20, a broadcast channel (physical broadcast channel (PBCH)), a downlink control channel (physical downlink control channel (PDCCH)), and the like may be used as downlink channels.

In the radio communication system 1, an uplink shared channel (physical uplink shared channel (PUSCH)) shared by each user terminal 20, an uplink control channel (physical uplink control channel (PUCCH)), a random access channel (physical random access channel (PRACH)), and the like may be used as uplink channels.

User data, higher layer control information, a system information block (SIB), and the like are transmitted on the PDSCH. The PUSCH may transmit the user data, higher layer control information, and the like. A master information block (MIB) may be transmitted on the PBCH.

Lower layer control information may be transmitted on the PDCCH. The lower layer control information may include, for example, downlink control information (DCI) including scheduling information of at least one of the PDSCH or the PUSCH.

Note that, the DCI for scheduling the PDSCH may be referred to as DL assignment, DL DCI, or the like, and the DCI for scheduling the PUSCH may be referred to as UL grant, UL DCI, or the like. Note that, PDSCH may be replaced with DL data and PUSCH may be replaced with UL data.

For detection of the PDCCH, a control resource set (CORESET) and a search space may be used. The CORESET corresponds to a resource that searches for DCI. The search space corresponds to a search area and a search method for PDCCH candidates. One CORESET may be associated with one or more search spaces. The UE may monitor the CORESET associated with a certain search space based on search space setting.

One search space may correspond to a PDCCH candidate corresponding to one or more aggregation levels. One or more search spaces may be referred to as a search space set. Note that the terms “search space”, “search space set”, “search space setting”, “search space set setting”, “CORESET”, “CORESET setting”, and the like in the present disclosure may be replaced with one another.

Uplink control information (UCI) including at least one of channel state information (CSI), delivery acknowledgement information (which may be referred to as, for example, hybrid automatic repeat request acknowledgement (HARQ-ACK), ACK/NACK, or the like), or scheduling request (SR) may be transmitted on the PUCCH. A random access preamble for establishing connection with a cell may be transmitted on the PRACH.

Note that, in the present disclosure, downlink, uplink, and the like may be expressed without “link”. Various channels may be expressed without adding “physical” at the beginning thereof.

In the radio communication system 1, a synchronization signal (SS), a downlink reference signal (DL-RS), and the like may be transmitted. In the radio communication system 1, a cell-specific reference signal (CRS), a channel state information reference signal (CSI-RS), a demodulation reference signal (DMRS), a positioning reference signal (PRS), a phase tracking reference signal (PTRS), or the like may be transmitted as the DL-RS.

The synchronization signal may be, for example, at least one of a primary synchronization signal (PSS) or a secondary synchronization signal (SSS). A signal block including the SS (PSS or SSS) and the PBCH (and the DMRS for the PBCH) may be referred to as an SS/PBCH block, an SS block (SSB), or the like. Note that, the SS, the SSB, or the like may also be referred to as a reference signal.

In the radio communication system 1, a measurement reference signal (sounding reference signal (SRS)), a demodulation reference signal (DMRS), or the like may be transmitted as an uplink reference signal (UL-RS). Note that, the DMRS may also be referred to as a user terminal-specific reference signal (UE-specific reference signal).

### (Base Station)

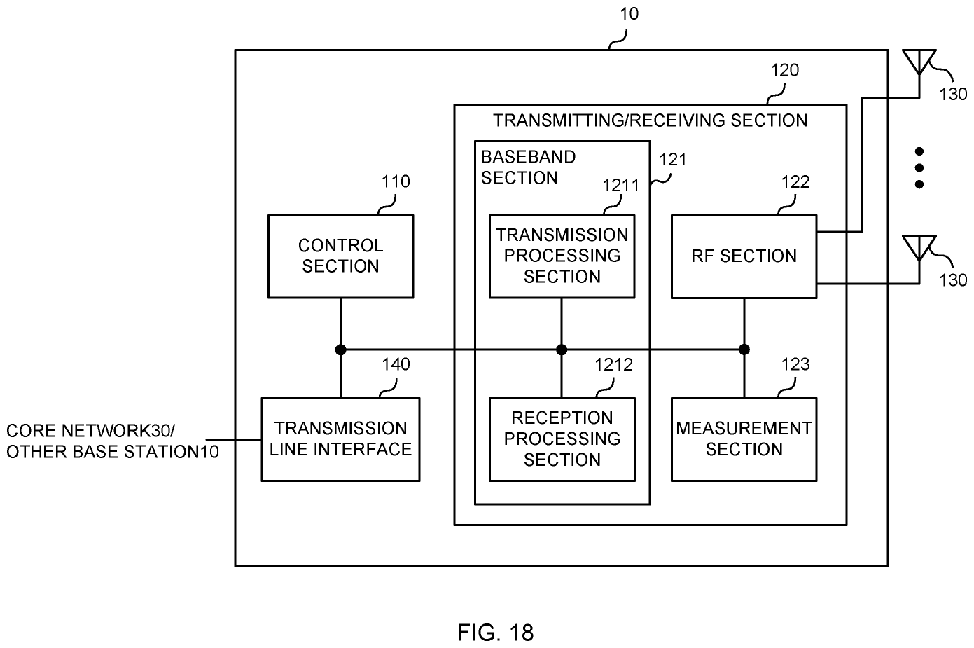

FIG. 18 is a diagram illustrating an example of a configuration of the base station according to one embodiment. The base station 10 includes a control section 110, a transmitting/receiving section 120, a transmitting/reception antenna 130, and a transmission line interface 140. Note that one or more control sections 110, one or more transmitting/receiving sections 120, one or more transmission/reception antennas 130, and one or more transmission line interfaces 140 may be provided.

Note that, although this example mainly describes functional blocks of a characteristic part of the present embodiment, it may be assumed that the base station 10 includes other functional blocks that are necessary for radio communication as well. A part of processing performed by each section described below may be omitted.

The control section 110 controls the entire base station 10. The control section 110 can include a controller, a control circuit, and the like that are described based on common recognition in the technical field related to the present disclosure.

The control section 110 may control signal generation, scheduling (for example, resource allocation or mapping), and the like. The control section 110 may control transmission/reception, measurement, and the like using the transmitting/receiving section 120, the transmission/reception antenna 130, and the transmission line interface 140. The control section 110 may generate data to be transmitted as a signal, control information, a sequence, and the like, and may forward the data, the control information, the sequence, and the like to the transmitting/receiving section 120. The control section 110 may perform call processing (such as setting or releasing) of a communication channel, state management of the base station 10, and management of a radio resource.

The transmitting/receiving section 120 may include a baseband section 121, a radio frequency (RF) section 122, and a measurement section 123. The baseband section 121 may include a transmission processing section 1211 and a reception processing section 1212. The transmitting/receiving section 120 can include a transmitter/receiver, an RF circuit, a baseband circuit, a filter, a phase shifter, a measurement circuit, a transmission/reception circuit, and the like that are described based on common recognition in the technical field related to the present disclosure.

The transmitting/receiving section 120 may be configured as an integrated transmitting/receiving section, or may include a transmitting section and a receiving section. The transmitting section may include the transmission processing section 1211 and the RF section 122. The receiving section may include the reception processing section 1212, the RF section 122, and the measurement section 123.

The transmission/reception antenna 130 can include an antenna described based on common recognition in the technical field related to the present disclosure, for example, an array antenna.

The transmitting/receiving section 120 may transmit the above-described downlink channel, synchronization signal, downlink reference signal, and the like. The transmitting/receiving section 120 may receive the above-described uplink channel, uplink reference signal, and the like.

The transmitting/receiving section 120 may form at least one of a Tx beam or a reception beam by using digital beam forming (for example, precoding), analog beam forming (for example, phase rotation), and the like.

The transmitting/receiving section 120 (transmission processing section 1211) may perform packet data convergence protocol (PDCP) layer processing, radio link control (RLC) layer processing (for example, RLC retransmission control), medium access control (MAC) layer processing (for example, HARQ retransmission control), and the like on, for example, data, control information, and the like acquired from the control section 110, to generate a bit string to be transmitted.

The transmitting/receiving section 120 (transmission processing section 1211) may perform transmission processing such as channel encoding (which may include error correcting encoding), modulation, mapping, filtering processing, discrete Fourier transform (DFT) processing (if necessary), inverse fast Fourier transform (IFFT) processing, precoding, or digital-analog conversion on the bit string to be transmitted, to output a baseband signal.

The transmitting/receiving section 120 (RF section 122) may perform modulation to a radio frequency range, filtering processing, amplification, and the like on the baseband signal, to transmit a signal in the radio frequency range via the transmission/reception antenna 130.

Meanwhile, the transmitting/receiving section 120 (RF section 122) may perform amplification, filtering processing, demodulation to a baseband signal, and the like on the signal in the radio frequency range received by the transmission/reception antenna 130.

The transmitting/receiving section 120 (reception processing section 1212) may apply reception processing such as analog-digital conversion, fast fourier transform (FFT) processing, inverse discrete Fourier transform (IDFT) processing (if necessary), filtering processing, demapping, demodulation, decoding (which may include error correction decoding), MAC layer processing, RLC layer processing, or PDCP layer processing on the acquired baseband signal, to acquire user data and the like.

The transmitting/receiving section 120 (measurement section 123) may perform measurement on the received signal. For example, the measurement section 123 may perform radio resource management (RRM), channel state information (CSI) measurement, and the like based on the received signal. The measurement section 123 may measure received power (for example, reference signal received power (RSRP)), received quality (for example, reference signal received quality (RSRQ), a signal to interference plus noise ratio (SINR), a signal to noise ratio (SNR)), signal strength (for example, received signal strength indicator (RSSI)), propagation path information (for example, CSI), and the like. The measurement result may be output to the control section 110.

The transmission line interface 140 may perform transmission/reception of a signal (backhaul signaling) to/from an apparatus included in the core network 30, another base station 10, or the like, and may perform acquisition, transmission, or the like of user data (user plane data), control plane data, and the like for the user terminal 20.

Note that, the transmitting section and the receiving section of the base station 10 in the present disclosure may include at least one of the transmitting/receiving section 120, the transmission/reception antenna 130, or the transmission line interface 140.

In at least one of a case in which a plurality of UL transmissions having the same priority overlap and a case in which a plurality of UL transmissions having different priority overlap, when the overlap is resolved using the plurality of steps, the transmitting/receiving section 120 may receive simultaneous transmission of the uplink control channel and the uplink shared channel in which transmission is supported in at least one of a plurality of steps.

### (User Terminal)

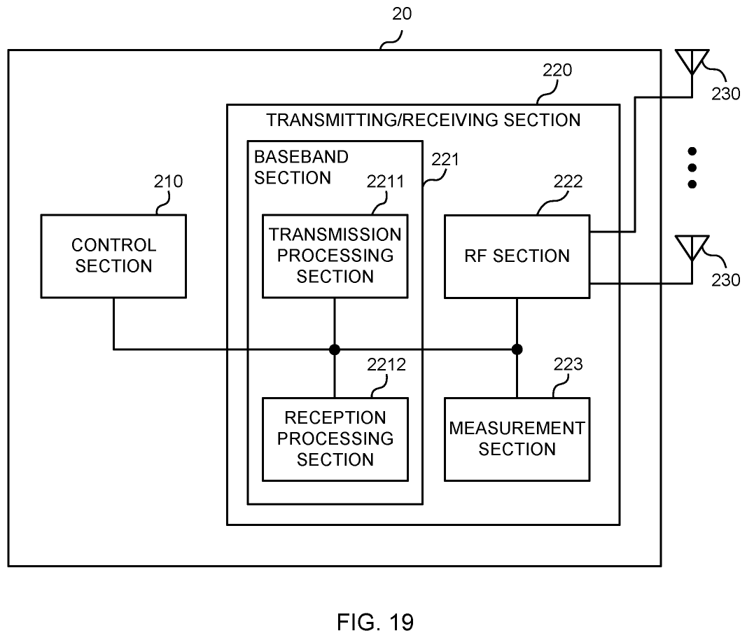

FIG. 19 is a diagram illustrating an example of a configuration of the user terminal according to one embodiment. The user terminal 20 includes a control section 210, a transmitting/receiving section 220, and a transmitting/reception antenna 230. Note that one or more of the control sections 210, one or more of the transmitting/receiving sections 220, and one or more of the transmission/reception antennas 230 may be included.

Note that, although this example mainly describes functional blocks of a characteristic part of the present embodiment, it may be assumed that the user terminal 20 includes other functional blocks that are necessary for radio communication as well. A part of processing performed by each section described below may be omitted.

The control section 210 controls the entire user terminal 20. The control section 210 can include a controller, a control circuit, and the like that are described based on common recognition in the technical field related to the present disclosure.

The control section 210 may control signal generation, mapping, and the like. The control section 210 may control transmission/reception, measurement, and the like using the transmitting/receiving section 220 and the transmission/reception antenna 230. The control section 210 may generate data, control information, a sequence, and the like to be transmitted as signals, and may forward the data, control information, sequence, and the like to the transmitting/receiving section 220.

The transmitting/receiving section 220 may include a baseband section 221, an RF section 222, and a measurement section 223. The baseband section 221 may include a transmission processing section 2211 and a reception processing section 2212. The transmitting/receiving section 220 can be implemented by a transmitter/receiver, an RF circuit, a baseband circuit, a filter, a phase shifter, a measurement circuit, a transmitting/receiving circuit, and the like that are described based on common recognition in the technical field related to the present disclosure.

The transmitting/receiving section 220 may be formed as an integrated transmitting/receiving section, or may include a transmitting section and a receiving section. The transmitting section may include the transmission processing section 2211 and the RF section 222. The receiving section may include the reception processing section 2212, the RF section 222, and the measurement section 223.

The transmission/reception antenna 230 can include an antenna described based on common recognition in the technical field related to the present disclosure, for example, an array antenna.

The transmitting/receiving section 220 may receive the above-described downlink channel, synchronization signal, downlink reference signal, and the like. The transmitting/receiving section 220 may transmit the above-described uplink channel, uplink reference signal, and the like.

The transmitting/receiving section 220 may form at least one of a Tx beam or a reception beam by using digital beam forming (for example, precoding), analog beam forming (for example, phase rotation), and the like.

The transmitting/receiving section 220 (transmission processing section 2211) may perform PDCP layer processing, RLC layer processing (for example, RLC retransmission control), MAC layer processing (for example, HARQ retransmission control), and the like on, for example, data, control information, and the like acquired from the control section 210, to generate a bit string to be transmitted.

The transmitting/receiving section 220 (transmission processing section 2211) may perform transmission processing such as channel encoding (which may include error correcting encoding), modulation, mapping, filtering processing, DFT processing (if necessary), IFFT processing, precoding, or digital-analog conversion on the bit string to be transmitted, to output a baseband signal.

Note that whether to apply DFT processing may be determined based on setting of transform precoding. In a case in which transform precoding is enabled for a certain channel (e.g., PUSCH), the transmitting/receiving section 220 (transmission processing section 2211) may perform DFT processing as the transmission processing in order to transmit the channel using a DFT-s-OFDM waveform. In a case in which it is not the case, DFT processing need not be performed as the transmission processing.

The transmitting/receiving section 220 (RF section 222) may perform modulation to a radio frequency range, filtering processing, amplification, and the like on the baseband signal, to transmit a signal in the radio frequency range via the transmission/reception antenna 230.

Meanwhile, the transmitting/receiving section 220 (RF section 222) may perform amplification, filtering processing, demodulation to a baseband signal, and the like on the signal in the radio frequency range received by the transmission/reception antenna 230.

The transmitting/receiving section 220 (reception processing section 2212) may apply reception processing such as analog-digital conversion, FFT processing, IDFT processing (if necessary), filtering processing, demapping, demodulation, decoding (which may include error correction decoding), MAC layer processing, RLC layer processing, or PDCP layer processing on the acquired baseband signal, to acquire user data and the like.

The transmitting/receiving section 220 (measurement section 223) may perform measurement on the received signal. For example, the measurement section 223 may perform RRM measurement, CSI measurement, and the like based on the received signal. The measurement section 223 may measure received power (for example, RSRP), received quality (for example, RSRQ, SINR, or SNR), signal strength (for example, RSSI), propagation path information (for example, CSI), and the like. The measurement result may be output to the control section 210.

Note that the transmitting section and the receiving section of the user terminal 20 in the present disclosure may include at least one of the transmitting/receiving section 220 or the transmission/reception antenna 230.

In at least one of a case in which a plurality of UL transmissions having the same priority overlap and a case in which a plurality of UL transmissions having different priorities overlap, when the overlap is resolved using the plurality of steps, the control section 210 may control the simultaneous transmission of the uplink control channel and the uplink shared channel in at least one of the plurality of steps.

The transmitting/receiving section 220 may perform the UL transmission in which the overlap is resolved.

The simultaneous transmission of the uplink control channel and the uplink shared channel may be applied in a step of performing multiplexing between the uplink control channel and the uplink shared channel having the same priority.

The simultaneous transmission of the uplink control channel and the uplink shared channel may be applied in a step of performing prioritization among different priorities.

In the step in which the simultaneous transmission of the uplink control channel and the uplink shared channel is applied, the control section 210 may determine the application of the simultaneous transmission of the uplink control channel and the uplink shared channel after the uplink control channel and the uplink shared channel are multiplexed.

### (Hardware Configuration)

Note that the block diagrams that have been used to describe the above embodiments illustrate blocks in functional units. These functional blocks (components) may be implemented in arbitrary combinations of at least one of hardware or software. The method for implementing each functional block is not particularly limited. That is, each functional block may be implemented by a single apparatus physically or logically aggregated, or may be implemented by directly or indirectly connecting two or more physically or logically separate apparatuses (in a wired manner, a radio manner, or the like, for example) and using these apparatuses. The functional block may be realized by combining the one apparatus or the plurality of apparatuses with software.

Here, the function includes, but is not limited to, determining, judging, calculating, computing, processing, deriving, investigating, searching, ascertaining, receiving, transmitting, outputting, accessing, solving, selecting, choosing, establishing, comparing, assuming, expecting, regarding, broadcasting, notifying, communicating, forwarding, configuring, reconfiguring, allocating, mapping, assigning, and the like. For example, a functional block (component) that has a transmission function may be referred to as a transmitting section (transmitting unit), a transmitter, and the like. In any case, as described above, the implementation method is not particularly limited.

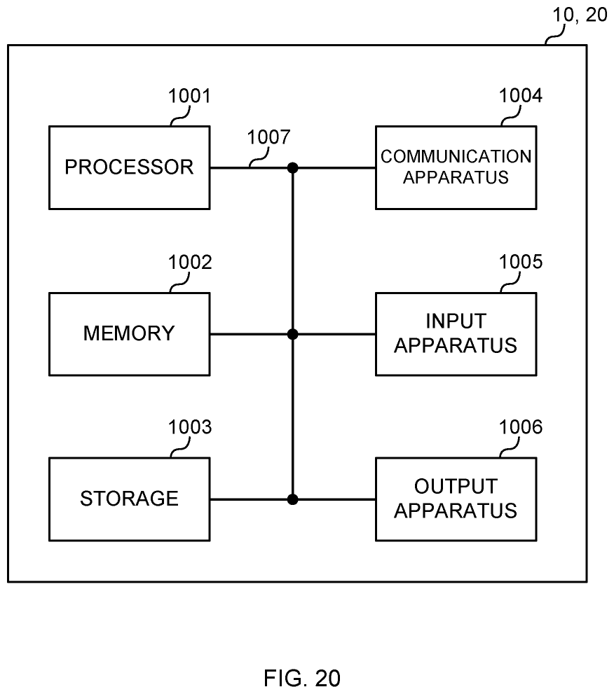

For example, the base station, the user terminal, and the like according to one embodiment of the present disclosure may function as a computer that executes the processing of the radio communication method of the present disclosure. FIG. 20 is a diagram illustrating an example of a hardware configuration of the base station and the user terminal according to one embodiment. Physically, the above-described base station 10 and user terminal 20 may be formed as a computer apparatus that includes a processor 1001, a memory 1002, a storage 1003, a communication apparatus 1004, an input apparatus 1005, an output apparatus 1006, a bus 1007, and the like.

Note that in the present disclosure, terms such as apparatus, circuit, device, section, and unit can be replaced with one another. The hardware configuration of the base station 10 and the user terminal 20 may be designed to include one or more of the apparatuses illustrated in the drawings, or may be designed not to include some apparatuses.

For example, although only one processor 1001 is shown, a plurality of processors may be provided. The processing may be executed by one processor, or the processing may be executed by two or more processors simultaneously or sequentially, or using other methods. Note that the processor 1001 may be implemented with one or more chips.

Each function of the base station 10 and the user terminal 20 is implemented by given software (program) being read on hardware such as the processor 1001 and the memory 1002, by which the processor 1001 performs operations, controlling communication via the communication apparatus 1004, and controlling at least one of reading or writing of data at the memory 1002 and the storage 1003.

The processor 1001 may control the whole computer by, for example, running an operating system. The processor 1001 may be implemented by a central processing unit (CPU) including an interface with peripheral equipment, a control apparatus, an operation apparatus, a register, and the like. For example, at least a part of the above-described control section 110 (210), transmitting/receiving section 120 (220), and the like may be implemented by the processor 1001.

The processor 1001 reads programs (program codes), software modules, data, etc. from at least one of the storage 1003 or the communication apparatus 1004 into the memory 1002, and performs various types of processing according to these. As the program, a program that causes a computer to execute at least a part of the operation described in the above-described embodiment is used. For example, the control section 110 (210) may be implemented by control programs that are stored in the memory 1002 and that operate on the processor 1001, and other functional blocks may be implemented likewise.

The memory 1002 is a computer-readable recording medium, and may include, for example, at least one of a read only memory (ROM), an erasable programmable ROM (EPROM), an electrically EPROM (EEPROM), a random access memory (RAM), or other appropriate storage media. The memory 1002 may be referred to as a register, a cache, a main memory (primary storage apparatus), and the like. The memory 1002 can store programs (program codes), software modules, etc. that are executable for implementing the radio communication method according to one embodiment of the present disclosure.

The storage 1003 is a computer-readable recording medium, and may include, for example, at least one of a flexible disk, a floppy (registered trademark) disk, a magneto-optical disk (for example, a compact disc ROM (CD-ROM)), a digital versatile disk, a Blu-ray (registered trademark) disk), a removable disk, a hard disk drive, a smart card, a flash memory device (for example, a card, a stick, or a key drive), a magnetic stripe, a database, a server, or other appropriate storage media. The storage 1003 may be referred to as “secondary storage apparatus.”

The communication apparatus 1004 is hardware (transmission/reception device) for performing inter-computer communication via at least one of a wired network or a wireless network, and is referred to as, for example, a network device, a network controller, a network card, a communication module, and the like. The communication apparatus 1004 may include a high frequency switch, a duplexer, a filter, a frequency synthesizer, and the like in order to implement, for example, at least one of frequency division duplex (FDD) or time division duplex (TDD). For example, the transmitting/receiving section 120 (220), the transmission/reception antenna 130 (230), and the like described above may be implemented by the communication apparatus 1004. The transmitting/receiving section 120 (220) may be implemented by being physically or logically separated into the transmitting section 120a (220a) and the receiving section 120b (220b).

The input apparatus 1005 is an input device for receiving input from the outside (for example, a keyboard, a mouse, a microphone, a switch, a button, a sensor and so on). The output apparatus 1006 is an output device that performs output to the outside (for example, a display, a speaker, or a light emitting diode (LED) lamp). Note that the input apparatus 1005 and the output apparatus 1006 may be provided in an integrated structure (for example, a touch panel).

These apparatuses such as the processor 1001 and the memory 1002 are connected by the bus 1007 so as to communicate information. The bus 1007 may be formed with a single bus, or may be formed with buses that vary between pieces of apparatus.

The base station 10 and the user terminal 20 may include hardware such as a microprocessor, a digital signal processor (DSP), an application specific integrated circuit (ASIC), a programmable logic device (PLD), or a field programmable gate array (FPGA), and some or all of the functional blocks may be implemented by using the hardware. For example, the processor 1001 may be implemented with at least one of these pieces of hardware.

### (Variations)

Note that terms described in the present disclosure and terms necessary for understanding the present disclosure may be replaced with terms that have the same or similar meanings. For example, channel, symbol, and signal (signal or signaling) may be replaced with one another. The signal may be a message. The reference signal can be abbreviated as an RS, and may be referred to as a pilot, a pilot signal, and the like, depending on which standard applies. A component carrier (CC) may be referred to as a cell, a frequency carrier, a carrier frequency, and the like.

A radio frame may be comprised of one or more periods (frames) in the time domain. Each of the one or more periods (frames) included in the radio frame may be referred to as a subframe. The subframe may include one or more slots in the time domain. The subframe may be a fixed time duration (for example, 1 ms) that is not dependent on numerology.

Here, the numerology may be a communication parameter used for at least one of transmission or reception of a certain signal or channel. For example, the numerology may indicate at least one of subcarrier spacing (SCS), a bandwidth, a symbol length, a cyclic prefix length, a transmission time interval (TTI), the number of symbols per TTI, a radio frame configuration, specific filtering processing performed by a transceiver in the frequency domain, or specific windowing processing performed by a transceiver in the time domain.

The slot may include one or more symbols in the time domain (orthogonal frequency division multiplexing (OFDM) symbols, single carrier frequency division multiple access (SC-FDMA) symbols, and the like). Also, a slot may be a time unit based on numerology.

The slot may include a plurality of mini slots. Each mini slot may include one or more symbols in the time domain. The mini slot may be referred to as a sub-slot. Each mini slot may include fewer symbols than the slot. PDSCH (or PUSCH) transmitted in a time unit larger than the mini slot may be referred to as “PDSCH (PUSCH) mapping type A”. PDSCH (or PUSCH) transmitted using a mini slot may be referred to as PDSCH (PUSCH) mapping type B.

A radio frame, a subframe, a slot, a mini slot and a symbol all represent the time unit in signal communication. The radio frame, the subframe, the slot, the mini slot, and the symbol may be called by other applicable names, respectively. Note that time units such as frame, subframe, slot, mini slot, and symbol in the present disclosure may be replaced with one another.

For example, one subframe may be referred to as TTI, a plurality of continuous subframes may be referred to as TTI, or one slot or one mini slot may be referred to as TTI. That is, at least one of the subframe or the TTI may be a subframe (1 ms) in the existing LTE, may be a period shorter than 1 ms (for example, one to thirteen symbols), or may be a period longer than 1 ms. Note that the unit to represent the TTI may be referred to as a “slot,” a “mini slot” and so on, instead of a “subframe.”

Here, a TTI refers to, for example, the minimum time unit of scheduling in radio communication. For example, in the LTE system, a base station performs scheduling to allocate radio resources (a frequency bandwidth, transmission power, and the like that can be used in each user terminal) to each user terminal in TTI units. Note that the definition of TTIs is not limited to this.

The TTI may be a transmission time unit of a channel-coded data packet (transport block), a code block, a codeword, etc. or may be a processing unit of scheduling, link adaptation, etc. When the TTI is given, a time interval (e.g., the number of symbols) to which a transport block, a code block, a codeword, or the like is actually mapped may be shorter than the TTI.

Note that, when one slot or one mini slot is called “TTI,” one or more TTIs (that is, one or multiple slots or one or more mini slots) may be the minimum time unit of scheduling. Also, the number of slots (the number of mini slots) to constitute this minimum time unit of scheduling may be controlled.

A TTI having a time duration of 1 ms may be referred to as a usual TTI (TTI in 3GPP Rel. 8 to 12), a normal TTI, a long TTI, a usual subframe, a normal subframe, a long subframe, a slot, or the like. A TTI that is shorter than the usual TTI may be referred to as a shortened TTI, a short TTI, a partial TTI (or fractional TTI), a shortened subframe, a short subframe, a mini slot, a sub-slot, a slot, or the like.

Note that long TTI (for example, normal TTI, or subframe) may be replaced with TTI having time duration exceeding 1 ms and short TTI (for example, shortened TTI) may be replaced with TTI having TTI duration less than the TTI duration of long TTI and not less than 1 ms.

A resource block (RB) is the unit of resource allocation in the time domain and the frequency domain, and may include one or more contiguous subcarriers in the frequency domain. The number of subcarriers included in the RB may be the same regardless of the numerology and may be, for example, twelve. The number of subcarriers included in an RB may be determined based on a numerology.

Also, an RB may include one or more symbols in the time domain, and may be one slot, one mini slot, one subframe or one TTI in length. One TTI, one subframe, etc. may each be comprised of one or more resource blocks.

Note that one or more RBs may be referred to as a physical resource block (PRB), a sub-carrier group (SCG), a resource element group (REG), a PRB pair, an RB pair, and the like.

A resource block may include one or more resource elements (REs). For example, one RE may be a radio resource field of one subcarrier and one symbol.

A bandwidth part (BWP) (which may be referred to as a partial bandwidth or the like) may represent a subset of contiguous common resource blocks (RBs) for a certain numerology in a certain carrier. Here, the common RB may be specified by the index of the RB based on a common reference point of the carrier. PRBs may be defined in a BWP and numbered within the BWP.

The BWP may include a BWP for UL (UL BWP) and a BWP for DL (DL BWP). For the UE, one or more BWPs may be set within one carrier.

At least one of the set BWPs may be active, and the UE does not have to expect transmission/reception of a given signal/channel outside the active BWP. Note that “cell”, “carrier”, etc. in the present disclosure may be replaced with “BWP”.

Note that the structures of radio frames, subframes, slots, mini slots, symbols and so on described above are merely examples. For example, configurations such as the number of subframes included in a radio frame, the number of slots per subframe or radio frame, the number of mini slots included in a slot, the number of symbols and RBs included in a slot or a mini slot, the number of subcarriers included in an RB, the number of symbols in a TTI, the symbol length, the length of cyclic prefix (CP), and the like can be variously changed.

The information, parameters, etc. described in the present disclosure may be represented using absolute values, or may be represented using relative values with respect to given values, or may be represented using other corresponding information. For example, a radio resource may be indicated by a given index.

The names used for parameters etc. in the present disclosure are in no respect limiting. Further, any mathematical expression or the like that uses these parameters may differ from those explicitly disclosed in the present disclosure. Since various channels (PUCCH, PDCCH, and the like) and information elements can be identified by any suitable names, various names allocated to these various channels and information elements are not restrictive names in any respect.

The information, signals, etc. described in the present disclosure may be represented using any of a variety of different technologies. For example, data, instruction, command, information, signal, bit, symbol and chip, all of which may be referenced throughout the herein-contained description, may be represented by voltages, currents, electromagnetic waves, magnetic fields or particles, optical fields or photons, or any combination of these.

Information, signals, etc. can be output in at least one of a direction from a higher layer to a lower layer or a direction from a lower layer to a higher layer. Information, signals and so on may be input and output via a plurality of network nodes.

The information, signals and so on that are input and/or output may be stored in a specific location (for example, in a memory), or may be managed in a control table. The information, signals, and the like to be input and output can be overwritten, updated, or appended. The output information, signals, and the like may be deleted. The information, signals and so on that are input may be transmitted to other pieces of apparatus.

Notification of information may be performed not only by using the aspects/embodiments described in the present disclosure but also using another method. For example, the notification of information in the present disclosure may be performed by using physical layer signaling (for example, downlink control information (DCI) or uplink control information (UCI)), higher layer signaling (for example, radio resource control (RRC) signaling, broadcast information (master information block (MIB)), system information block (SIB), or the like), or medium access control (MAC) signaling), another signal, or a combination thereof.

Note that the physical layer signaling may be referred to as Layer 1/Layer 2 (L1/L2) control information (L1/L2 control signal), L1 control information (L1 control signal), and the like. The RRC signaling may be referred to as an RRC message, and may be, for example, an RRC connection setup message, an RRC connection reconfiguration message, and the like. The MAC signaling may be notified using, for example, an MAC control element (CE).

Also, reporting of given information (for example, reporting of information to the effect that “X holds”) does not necessarily have to be sent explicitly, and can be sent implicitly (for example, by not reporting this piece of information, by reporting another piece of information, and so on).

Decisions may be made in values represented by one bit (0 or 1), may be made in Boolean values that represent true or false, or may be made by comparing numerical values (for example, comparison against a given value).

Software, whether being called “software,” “firmware,” “middleware,” “microcode” or “hardware description language,” or called by other names, should be interpreted broadly, to mean instructions, instruction sets, code, code segments, program codes, programs, subprograms, software modules, applications, software applications, software packages, routines, subroutines, objects, executable files, execution threads, procedures, functions and so on.

Also, software, commands, information and so on may be transmitted and received via communication media. For example, when software is transmitted from a website, a server, or another remote source by using at least one of a wired technology (coaxial cable, optical fiber cable, twisted pair, digital subscriber line (DSL), or the like) or a radio technology (infrared rays, microwaves, and the like), at least one of the wired technology or the radio technology is included within the definition of a transmission medium.

The terms “system” and “network” used in the present disclosure may be used interchangeably. The “network” may mean an apparatus (for example, a base station) included in the network.

In the present disclosure, terms such as “precoding”, “precoder”, “weight (precoding weight)”, “quasi-co-location (QCL)”, “transmission configuration indication state (TCI state)”, “spatial relation”, “spatial domain filter”, “transmit power”, “phase rotation”, “antenna port”, “antenna port group”, “layer”, “number of layers”, “rank”, “resource”, “resource set”, “resource group”, “beam”, “beam width”, “beam angle”, “antenna”, “antenna element”, and “panel” can be used interchangeably.

In the present disclosure, terms such as “base station (BS)”, “radio base station”, “fixed station”, “NodeB”, “eNodeB (eNB)”, “gNodeB (gNB)”, “access point”, “transmission point (TP)”, “reception point (RP)”, “transmission/reception point (TRP)”, “panel”, “cell”, “sector”, “cell group”, “carrier”, and “component carrier”, can be used interchangeably. The base station may be called a term such as macro cell, small cell, femto cell, or pico cell.

The base station can accommodate one or more (for example, three) cells. In a case in which the base station accommodates a plurality of cells, the entire coverage area of the base station can be partitioned into a plurality of smaller areas, and each smaller area can provide communication services through a base station subsystem (for example, small base station for indoors (remote radio head (RRH))). The term “cell” or “sector” refers to a part or the whole of a coverage area of at least one of the base station or the base station subsystem that performs a communication service in this coverage.

In the present disclosure, the terms such as “mobile station (MS)”, “user terminal”, “user equipment (UE)”, and “terminal” can be used interchangeably.

A mobile station is sometimes called “subscriber station,” “mobile unit,” “subscriber unit,” “wireless unit,” “remote unit,” “mobile device,” “wireless device,” “wireless communication device,” “remote device,” “mobile subscriber station,” “access terminal,” “mobile terminal,” “wireless terminal,” “remote terminal,” “handset,” “user agent,” “mobile client,” “client,” or some other suitable terms.

At least one of the base station or the mobile station may be called transmitting apparatus, receiving apparatus, radio communication apparatus, and the like. Note that at least one of the base station or the mobile station may be a device mounted on a moving object, a moving object itself, and the like. The moving object may be a transportation (for example, a car or an airplane), an unmanned moving object (for example, a drone or an autonomous car), or a (manned or unmanned) robot. Note that at least one of the base station or the mobile station also includes an apparatus that does not necessarily move during a communication operation. For example, at least one of the base station or the mobile station may be an Internet of Things (IoT) device such as a sensor.

Base station in the present disclosure may be replaced with user terminal. For example, each aspect/embodiment of the present disclosure may be applied to a configuration in which communication between the base station and the user terminal is replaced with communication among a plurality of user terminals (which may be referred to as, for example, device-to-device (D2D) or vehicle-to-everything (V2X)). In this case, the user terminal 20 may have the function of the above-described base station 10. Words such as “uplink” and “downlink” may be replaced with words corresponding to terminal-to-terminal communication (for example, “side link”). For example, uplink channel, downlink channel, and the like may be replaced with side link channel.

Likewise, user terminal in the present disclosure may be replaced with base station. In this case, the base station 10 may have the functions of the user terminal 20 described above.

In the present disclosure, an operation performed by the base station may be performed by an upper node thereof in some cases. In a network including one or more network nodes with base stations, it is clear that various operations performed for communication with a terminal can be performed by a base station, one or more network nodes (examples of which include but are not limited to mobility management entity (MME) and serving-gateway (S-GW)) other than the base station, or a combination thereof.

The aspects/embodiments illustrated in the present disclosure may be used individually or in combinations, which may be switched depending on the mode of implementation. The order of processing procedures, sequences, flowcharts, and the like of the aspects/embodiments described in the present disclosure may be re-ordered as long as there is no inconsistency. For example, the methods described in the present disclosure have presented various step elements using an exemplary order, and are not limited to the presented specific order.

Each aspect/embodiment described in the present disclosure may be applied to a system using long term evolution (LTE), LTE-advanced (LTE-A), LTE-beyond (LTE-B), SUPER 3G, IMT-Advanced, 4th generation mobile communication system (4G), 5th generation mobile communication system (5G), 6th generation mobile communication system (6G), xth generation mobile communication system (xG) (x is, for example, an integer or decimal), future radio access (FRA), new radio access technology (RAT), new radio (NR), new radio access (NX), future generation radio access (FX), global system for mobile communications (GSM (registered trademark)), CDMA 2000, ultra mobile broadband (UMB), IEEE 802.11 (Wi-Fi (registered trademark)), IEEE 802.16 (WIMAX (registered trademark)), IEEE 802.20, Ultra-WideBand (UWB), Bluetooth (registered trademark), or another appropriate radio communication method, a next generation system expanded based on these, and the like. A plurality of systems may be combined and applied (for example, a combination of LTE or LTE-A and 5G).

The phrase “based on” used as in the present disclosure does not mean “based only on,” unless otherwise specified. In other words, the phrase “based on” means both “based only on” and “based at least on.”

Reference to elements with designations such as “first,” “second,” and the like as used in the present disclosure does not generally limit the number/quantity or order of these elements. These designations can be used in the present disclosure, as a convenient way of distinguishing between two or more elements. Consequently, reference to the first and second elements does not imply that only two elements may be employed, or that the first element must precede the second element in some way.

The term “determining” as used in the present disclosure may include a wide variety of operations. For example, “determining” may be regarded as “determining” judging, calculating, computing, processing, deriving, investigating, looking up (or searching or inquiring) (for example, looking up in a table, database, or another data structure), ascertaining, and the like.

To “judge” and “determine” as used in the present disclosure may be interpreted to mean making judgements and determinations related to receiving (for example, receiving information), transmitting (for example, transmitting information), inputting, outputting, accessing (for example, accessing data in memory), and the like.

To “judge” and “determine” as used in the present disclosure may be interpreted to mean making judgements and determinations related to resolving, selecting, choosing, establishing, comparing, and the like. In other words, to “judge” and “determine” as used in the present disclosure may be interpreted to mean making judgements and determinations related to some action.

“Judgment (determination)” may be interpreted as “assuming,” “expecting,” “considering,” or the like.

The term “maximum transmission power” described in the present disclosure may mean the maximum value of transmission power, the nominal UE maximum transmit power, or the rated UE maximum transmit power.

As used in the present disclosure, the terms “connected” and “coupled”, or any variation of these terms mean all direct or indirect connections or coupling between two or more elements, and may include the presence of one or more intermediate elements between two elements that are “connected” or “coupled” to each other. The coupling or connection between the elements may be physical, logical, or a combination of these. For example, “connection” may be replaced with “access”.

As used in the present disclosure, when two elements are connected, these elements may be considered “connected” or “coupled” to each other by using one or more electrical wires, cables, printed electrical connections, and the like, and, as a number of non-limiting and non-inclusive examples, by using electromagnetic energy having wavelengths in the radio frequency domain, microwave, and optical (both visible and invisible) regions, or the like.

In the present disclosure, the phrase “A and B are different” may mean “A and B are different from each other”. Note that the phrase may mean that “A and B are different from C”. The terms such as “leave” “coupled” and the like may be interpreted as “different”.

When the terms such as “include”, “including”, and variations of these are used in the present disclosure, these terms are intended to be inclusive, in a manner similar to the way the term “comprising” is used. Further, the term “or” as used in the present disclosure is intended to be not an exclusive-OR.

In the present disclosure, when articles, such as “a”, “an”, and “the” are added in English translation, the present disclosure may include the plural forms of nouns that follow these articles.

In the above, the invention according to the present disclosure has been described in detail; however, it is obvious to those skilled in the art that the invention according to the present disclosure is not limited to the embodiments described in the present disclosure. The invention according to the present disclosure can be implemented as corrected and changed aspects without departing from the gist and the scope of the invention decided by the descriptions of claims. Consequently, the description of the present disclosure is provided only for the purpose of explaining examples, and should by no means be construed to limit the invention according to the present disclosure in any way.

The present application is based on Japanese Patent Application No. 2021-132978 filed on Aug. 17, 2021. All the contents of the present application are incorporated herein.

1.-5. (canceled)

6. A terminal comprising:
a transmitter that transmits capability information of the terminal, the capability information relating to support of simultaneous transmission of multiple uplink (UL) transmissions with different priorities; and
a processor that, when the multiple UL transmissions overlap in a time domain, controls, based on a given condition, to perform simultaneous transmission without performing multiplexing of the multiple UL transmissions.

7. The terminal according to claim 6, wherein the given condition is whether simultaneous transmission of the multiple UL transmissions is applied or not.

8. The terminal according to claim 6, wherein when simultaneous transmission of the multiple UL transmissions is not applied and when multiplexing of the multiple UL transmissions is not performed, the processor does not perform a UL transmission with a lower priority among the multiple UL transmissions.

9. The terminal according to claim 6, wherein the multiple UL transmissions are a physical uplink control channel (PUCCH) transmission and a physical uplink shared channel (PUSCH) transmission.

10. A radio communication method for a terminal, comprising:
transmitting capability information of the terminal, the capability information relating to support of simultaneous transmission of multiple uplink (UL) transmissions with different priorities; and
when the multiple UL transmissions overlap in a time domain, controlling, based on a given condition, to perform simultaneous transmission without performing multiplexing of the multiple UL transmissions.

11. A base station comprising:
a receiver that receives capability information of a terminal, the capability information relating to support of simultaneous transmission of multiple uplink (UL) transmissions with different priorities; and
a processor that, when the multiple UL transmissions overlap in a time domain, controls, based on a given condition, reception processing for the multiple UL transmissions that are simultaneously transmitted, without performing multiplexing of the multiple UL transmission.

12. A system comprising a terminal and a base station, wherein
the terminal comprises:
a transmitter that transmits capability information of the terminal, the capability information relating to support of simultaneous transmission of multiple uplink (UL) transmissions with different priorities; and
a processor that, when the multiple UL transmissions overlap in a time domain, controls, based on a given condition, to perform simultaneous transmission without performing multiplexing of the multiple UL transmissions, and
the base station comprises:
a receiver that receives the capability information; and
a processor that, when the multiple UL transmissions overlap in the time domain, controls, based on the given condition, reception processing for the multiple UL transmissions that are simultaneously transmitted, without performing multiplexing of the multiple UL transmissions.
